(19) United States
(12) Patent Application Publication
(10) Pub. No.: US 2014/0187842 A1
(43) Pub. Date: Jul. 3, 2014

(54) Device for Disposal and Neutralization of Pharmaceutical Agents

(71) Applicant: QRxPharma Ltd., North Sydney NSW (AU)

(72) Inventors: John W. Holaday, Bethesda, MD (US); Edward M. Rudnic, Potomac, MD (US); Beth A. Burnside, Bethesda, MD (US); Marcus Schestopol, Chevy Chase, MD (US); Donald Treacy, Woodbine, MD (US); Michael Vachon, Quebec (CA); Sean Higgins, Baltimore, MD (US); Gary W. Pace, La Jolla, CA (US)

(73) Assignee: QRxPharma Ltd., North Sydney NSW (AU)

(21) Appl. No.: 14/142,736

(22) Filed: Dec. 27, 2013

Related U.S. Application Data
(60) Provisional application No. 61/746,567, filed on Dec. 28, 2012.
(60) Provisional application No. 61/805,504, filed on Mar. 26, 2013.

(51) Int. Cl. B09B 3/00

(52) U.S. Cl. CPC B09B 3/0075
USPC 588/313; 422/129

(57) ABSTRACT

Device for the neutralization and disposal of unused human or animal pharmaceutical medicament. The device comprises a disposal device material that contains one or more disposal device agents. The disposal device material may also contain additional components to promote mixing, or neutralization of the active agent of the medicament. The disposal device material can be in the form of pellets, beads, beadlets, granules, or the like, and can be incorporated into a disposal device reservoir. The disposal device can be dispensed with a medicament, and the device can be used when the patient has finished using the medicament and there is material left over for disposal.

### CROSS REFERENCE TO RELATED APPLICATIONS

This application claims priority to U.S. provisional application Ser. No. 61/746,567 filed on Dec. 28, 2012, and to U.S. provisional application Ser. No. 61/805,504 filed on Mar. 26, 2013. Each of these applications is incorporated herein by reference.

### FIELD OF THE INVENTION

The present invention relates to a device for the disposal and/or neutralization of unused human or animal medicaments, which includes pharmaceutical products such as prescription drugs and over-the-counter (OTC) medications, as well as any other substance that can cause harm if ingested. The disposal device may comprise a material, such as a powder, pellets, beads, beadlets, granules, or the like, housed in a reservoir in the form of, for example, a sachet or other individual packet. The reservoir can be added to an existing container or incorporated into the walls or bottom of a container or a cap to accompany the medicament when issued or given to a patient. The disposal device material can prevent the medicament from being further used and/or prevent the active agent(s) of the medicament from being removed to an appreciable extent and/or rate from the medicament.

### BACKGROUND OF THE INVENTION

Many medicaments, such as pharmaceutical drugs that are psychoactive or analgesic, have significant ability to cause euphoria or pleasurable effects, and are thereby at risk for abuse. In many instances where abuse occurs, the drugs are crushed, melted, dissolved or altered, and are then inhaled, snorted, injected or swallowed in a manner or dosage that is inconsistent with their intended or safe use. Tampering of immediate release formulations, or extended release formulations in particular, will rapidly deliver to the abuser a massive dose and produce a variety of serious and life threatening side effects, including respiratory depression and failure, sedation, cardiovascular collapse, coma, and death. Likewise, there are a number of medicaments such as chemotherapeutics that, when administered at any level, cause undesirable side effects. Other medicaments, such as antibiotics, accumulate in the environment and may increase the evolution of antibiotic resistant organisms when the medicaments are disposed by such means as leaving them in the garbage or flushing them in a toilet. It is important to dispose of such unused medication properly to prevent wrongful administration or contamination of waste-water treatment facilities.

One type of medicament that is particularly targeted for tampering is opioids, which can be extracted from their dosage form in a variety of ways. For example, the dosage form can be mixed with a suitable solvent (e.g., water or alcohol) and then filtered to extract the opioid for intravenous injection. Extended release dosage forms of an opioid can be dissolved in water, alcohol or another “recreational solvent” to hasten the release of the opioid, and the resulting solution can be ingested orally; this provides high peak plasma concentrations of the opioid and maximum euphoria effects.

Other medicaments such as highly potent drugs (e.g., alprazolam and chlorpromazine), drugs with strong side effect profiles such as chemotherapeutics (e.g., bendamustine, cisplatin, paclitaxel, topotecan, thalidomide, and related substances), and psychoactive agents may be dangerous if administered accidentally, and are harmful to the environment if disposed into the sewer or landfills. Other categories of problematic medicaments include antibiotics, cardiovascular drugs (e.g., antihypertensives and statins), and erectile dysfunction drugs (e.g., viagra).

Once a patient is done using a medication, which frequently constitutes taking only a portion of the amount provided, the medication is often disposed of unchanged in the household waste or flushed down the toilet. Alternatively, leftover medication can remain in the family or household medicine cabinet, available for both unintended use and abuse. Both of these medication endpoints have serious unintended consequences. If the product is disposed in the household waste or flushed into the sewer system, it can pass unchanged into the environment where it will likely create toxic effects on animals and cause an imbalance in the local ecosystem. This disposal of medicaments has poisonous effects and is gaining wide opposition.¹ In fact, the ramifications of such drug disposal methods on the environment and human health are currently under review by the U.S. Environmental Protection Agency (EPA), Office of Research and Development (ORD), National Exposure Research Laboratory (NERL), Environmental Sciences Division (ESD). The goal of the EPA and other organizations is to reduce the entry of active pharmaceutical agents into the environment, with the ultimate objective to minimize exposure (both chronic and acute) to humans and wildlife alike.² ¹ See S Shah, As Pharmaceutical Use Soars, Drugs Taint Water and Wildlife, YALE ENVIRONMENT 360 (Apr. 15, 2010), http://e360.yale.edu/feature/as_pharmaceutical_use_soars_drugs_taint_water_and_wildlife/2263/² C G Daughton, Drugs and the Environment: Stewardship & Sustainability, NATIONAL EXPOSURE RESEARCH LABORATORY, ENVIRONMENTAL SCIENCES DIVISION, US EPA, LAS VEGAS, NEVADA, REPORT NERL-LV-ESD 10/081, EPA/600/R-10/106 (Sep. 12, 2010), http://www.epa.gov/nerlesd1/bios/daughton/APM200-2010.pdf

A major safety campaign is currently underway in the United States to dispose of drugs at risk for abuse in a manner that will prevent their misuse, either by accidental administration or by illicit use. The United States Food and Drug Administration (FDA), the Drug Enforcement Agency (DEA), and White House Office of National Drug Control Policy (ONDCP) offer guidance for unused pharmaceutical disposal, which includes directions to flush drugs down the toilet or to mix drugs with coffee grounds to throw away, and encouragement to participate in “take-back” programs. This guidance, however, is dependent on consumer compliance and teaches processes that maintain environmental exposure.

There are many examples of centralized collection or mail-in pharmaceutical disposal systems that use traditional large-scale industry approaches for the disposal and/or neutralization of pharmaceutical agents. To be successful, such systems require substantive compliance from the consumer and create risks to the collectors, such as law enforcement or pharmacies, as they do not have tight control of the disposed or returned pharmaceutical agents (including scheduled drugs) that they receive. As a result, a significant amount of the unused pharmaceuticals accumulate in consumers' homes, are released into the environment through disposal into the water system, are misused by persons other than those receiving the prescription, or enter illegal trade channels.

Another approach is to dispose of unused pharmaceutical agents using a secondary containment distributed collection system. These systems involve emptying unused drugs into a pouch, bag or bottle that contains neutralizing or aggregating agents, or emptying a second container with such agents into a first container and adding water.³ But an issue that applies to approaches involving separate collection devices is that they are limited in the amount of drug they can absorb. For instance, activated charcoal in disposal devices is often difficult to wet, which can lead to lack of mixing with the drug product and may prevent absorption of the intended drug substance. Moreover, the products can be inconvenient to obtain, because they must be ordered separately from the purchase of the prescription. ³ See U.S. patent application Ser. No. 10/457,562, Publication No. 2004/0033255 and (published Feb. 19, 2004); see also U.S. patent application Ser. No. 12/412,144, Publication No. 2009/0180936 (published Jul. 16, 2009)

To prevent misuse of medicaments, especially drugs at risk for abuse, various technologies have been developed. One approach is to combine in the same pharmaceutical formulation the active agent and a second agent that is capable of limiting the psychotropic effect of the active agent when the formulation is taken parenterally. An example is a combination of methadone and naloxone.⁴ ⁴ See U.S. Pat. No. 3,773,955 (issued Nov. 20, 1973); see also U.S. Pat. No. 3,966,940 (issued Jun. 29, 1976)

Approaches have also been developed that aim to prevent tampering of opioids. For example, one method is to inter-disperse an opioid and an antagonist in a pharmaceutical formulation, such that the antagonist is “sequestered” in a form that prevents it from being released when the medicinal product is taken by its normal oral route.⁵ However, a concern regarding this approach is that the necessary chemical association of the two compounds can lead to a complex manufacturing process and high production costs. Also, leaching of the antagonist into the bloodstream can block the desired pain relieving therapeutic effect of the opioid. ⁵ See U.S. Pat. No. 6,696,088 (issued Feb. 24, 2004)

Another approach is a dosage form in which the opioid is associated with an antagonist and an irritant that is sequestered in a closed compartment, such that tampering with the dosage form leads to release of the irritant.⁶ Yet, preparation of this dosage form requires the association of three active agents and the creation of compartments, which makes its manufacture complex and more costly than a simple dosage form such as a tablet. ⁶ See U.S. Pat. No. 7,332,182 (issued Feb. 19, 2008)

Other approaches do not involve an association of the opioid or active substance with an antagonist, but rather the dosage form is manufactured wherein the opioid forms a salt with one or more fatty acids, thereby increasing its lipophilicity and preventing its immediate release if the pharmaceutical form is tampered.⁷ This type of dosage form requires chemical conversion of the active agent. ⁷ See U.S. Pat. No. 7,771,707 (issued Aug. 10, 2010)

A general issue with the approaches named above is that the manufacturer must take the time to incorporate, test, and gain approval from the FDA to market such abuse deterrent technologies, which can take 5-10 years to produce. There are numerous drugs on the market right now for which an abuse deterrent system will never be incorporated. These drugs will continue to harm people and are becoming a public health issue across the United States.

There is therefore a need for a convenient and widely distributed or easily obtainable disposal device that allows for the safe disposal of medicaments that are no longer needed by the patient to whom the product was intended or prescribed. And such a need to develop an effective disposal means of such products will become greater as the drugs become more commonly prescribed. For example, the National Cancer Institute estimates that nearly 12 million Americans with a history of cancer were alive in January 2008, and about 1,638,910 new cancer cases are expected to be diagnosed in 2012,⁸ thereby increasing the use of chemotherapeutics. Meanwhile, opioid use and abuse has steadily increased over the past decade.⁹ Thus, an effective disposal device for unused medicaments is critical. ⁸ Cancer Facts & Figures 2012, AMERICAN CANCER SOCIETY (2012), http://www.cancer.org/acs/groups/content/@epidemiologysurveilance/documents/document/acspc-031941.pdf⁹ T. Catan & E. Perez, A Pain-Drug Champion Has Second Thoughts, THE WALL STREET JOURNAL (Dec. 17, 2012, 11:36 AM ET), http://online.wsj.com/article/SB10001424127887324478304578173342657044604.html.

### SUMMARY OF THE INVENTION

Various embodiments of the present invention relate to a device for the disposal and/or neutralization of unused human or animal medicaments, such as prescribed or non-prescribed medications, as well as any substance that can be toxic if ingested. The disposal device comprises a disposal device material that can render a medicament unusable according to the use instructions, unavailable for extraction for abuse, and/or generally ineffective in achieving its intended purpose, for example, by forming a gel or mass about the medicament, by neutralizing and/or antagonizing the active agents in the medicament, etc. In certain embodiments, the disposal device material is in the form of a powder, pellet, bead, beadlet, granule, or the like, or a combination thereof.

In embodiments of the present invention, the disposal device material comprises one or more disposal device agents. In certain embodiments, the one or more disposal device agents may solidify, in part or fully, after some period of time and/or may slow extraction of one or more active agents in the medicament after mixing the medicament with the disposal device material and an aqueous or alcoholic solvent. In some embodiments, the one or more disposal device agents are both hydrophilic and hydrophobic, and may comprise polyacrylic acid, hydroxypropyl methylcellulose (HPMC), HPMC: hydroxypropyl cellulose mixture, polyvinylpyrrolidone, polyethylene oxide, methylcellulose, xanthan gum, guar gum, hydroxypropyl cellulose, polyethylene glycol, methacrylic acid copolymer, colloidal silicon dioxide, cellulose gum, starch, sodium starch glycolate, sodium alginate, or combinations thereof.

In certain embodiments, the one or more disposal device agents may be a substance, such as a dry powder, that forms a paste when mixed with a solvent, such as water. The paste may liberate heat and then harden. An example is plaster of Paris (calcium sulfate (gypsum)), lime plaster, or cement plaster.

In some embodiments, the disposal device material may further comprise other components. For example, the disposal device may comprise components that can render the medicament unusable or unavailable for extraction or abuse, such as by neutralizing the medicament. In certain embodiments, these one or more neutralizing components may interact with the medicament to degrade the medicament so that it is unusable or unabusable, or to diminish the medicament's physiological and/or neurological effects. In other embodiments, the neutralizing components may provide their own therapeutic effect upon administration that neutralizes or antagonizes the therapeutic effect of the medicament. In some embodiments in which the medicament comprises one or more opioids, the neutralizing components comprise opioid inverse agonists, opioid antagonists, or a combination thereof.

In embodiments of the present invention, the disposal device material may further comprise other components, such as a hardening agent, a pH-modifier, or other components that affect the recovery of the pharmaceutical dosage form. In certain embodiments, the disposal device may further comprise components that produce an effervescent effect, thereby aiding in the disintegration and mixing process of the medicament; this is especially suitable for disposing of solid oral dosage forms that would benefit from additional continued agitation.

In some embodiments, the other components may be co-formulated with the one or more disposal device agents, for example, in the same powder, bead, etc., as the one or more disposal device agents. In certain embodiments, the other components may be combined with the one or more disposal device agents, for example, in separate powder, beads, etc., as the disposal device agents. In particular embodiments, there may be a combination of components that are co-formulated with the one or more disposal device agents and components that are combined with the one or more disposal device agents.

In certain embodiments, the disposal device further comprises a disposal device reservoir that houses or contains the disposal device material. The disposal device reservoir may be dispensed within a medicament container or may be separate from the medicament container. In some embodiments, the reservoir is itself a container that is easy to open, such as a plastic cup with a removable foil lid, a plastic or cardboard bottle or box with a re-sealable lid, a re-sealable bag, etc. Other examples of the forms of the disposal device reservoir may include, but are not limited to, a sachet, packet, bottle, bottle cap, vial, membrane enclosures, and the like. In embodiments in which the disposal device reservoir is in the form of a sachet, the sachet can be made of material that dissolves, or can be made of a material which requires the user to open the sachet for use.

In some embodiments, the disposal device reservoir, and the disposal device material therein, are incorporated into the fabrication of a medicament container, such as in or along the internal bottom or side-wall surfaces or in the medicament container lid or cap (e.g., a child resistant cap or a permanently locking cap).

Further embodiments of the invention relate to medicament containers that comprise a disposal device reservoir and disposal device material therein, incorporated into the fabrication of the medicament container, as described above.

Various embodiments of the invention relate to a method of disposing and/or neutralizing an unused medicament, comprising mixing the unused medicament with a disposal device material and a solvent, such as a hydrophilic diluent. In some embodiments, the solvent is water, alcohol, vinegar, or bleach.

In some embodiments, the medicament is in an oral dosage form such as, but not limited to, a tablet, capsule, or other solid oral product. In certain embodiments, the disposal device material and a solvent, such as water, are added to the medicament container that has any unused portion or amount of the medicament. The disposal device can be used once the patient has completed the course of therapy, regardless of whether completion constitutes using the entire medicament dispensed to the patient. In certain embodiments, once the contents are treated with the disposal device material, the medicament container can then be deposited into the household, industrial or other suitable waste container for disposal.

In some embodiments, the medicament is in the form of an injectable, solution, suspension, or other liquid dosage form. In certain embodiments, any remaining liquid medicament can be added to the disposal device reservoir. The liquid medicament itself may suffice as a solvent for mixing with the disposal device material, or a solvent may be combined with the liquid medicament and the disposal device material.

In further embodiments where the disposal device material is incorporated in the manufacture of the medicament container or container cap, the disposal device material may be co-formulated or incorporated as separate reagents.

In certain embodiments, the disposal device can be utilized with any substance that may be harmful or toxic to ingest or otherwise be administered. Preferably, the disposal device can be utilized with one or more medicaments, which may include pharmaceutical products such as prescription drugs and OTC drugs, or alternative therapies. In some embodiments, the pharmaceutical products may be anti-infectives, antineoplastics, biologicals, cardiovascular agents, central nervous system agents, chemotherapeutics, coagulation modifiers, gastrointestinal agents, hormones, immunologic agents, metabolic agents, psychotherapeutic agents, respiratory agents, or topical agents. In certain embodiments, the OTC drugs may be, for example, aspirin, Advil®, or Tylenol®. In some embodiments, the alternative therapies may be vitamins, nutritional supplements, natural/plant derived products, yeast and other fermented supplements, or other naturally derived therapeutic agents.

In embodiments of the invention, the one or more medicaments may be abusable drugs such as schedule I, II, III, or IV drugs. These drugs include opiate and opiate derivatives, hallucinogenic or psychedelic substances, depressants, and stimulants.

In certain embodiments, the one or more medicaments may be household animal medicaments such as flea and tick treatments. These treatments are often left over after a pet is deceased, and are considered poisonous if ingested by small children.

In some embodiments, the one or more medicaments may be drugs that are past their expiration date.

In certain embodiments, the disposal device can be utilized with one or more abusable drugs comprising morphine and oxycodone.

In certain embodiments the disposal device can be used with multiple medicaments in need of disposal at the same time. This can include, but is not limited to, the medicament dispensed with the disposal device and medicaments not dispensed with the disposal device.

### BRIEF DESCRIPTION OF THE FIGURES

For a more complete understanding of the invention, reference is made to the following description and accompanying drawings, as follows:

FIGS. 1a-c show embodiments of the invention in which the disposal device reservoir is in the form of a sachet. FIG. 1a shows a sachet (1). FIG. 1b shows a side view of a sachet (1), with a section A′-A.′ FIG. 1c shows the A′-A′ section of the sachet of FIG. 1b, with the disposal device material (2).

FIGS. 2a-c show embodiments of the invention in which the disposal device reservoir is in the form of a sachet (1), and the sachet is placed into a medicament container (3). FIG. 2a shows an oblique view of a medicament container (3) with a lid (4). FIG. 2b shows the sachet (1) and the medicament container (3) with its lid (4) removed. FIG. 2c shows the sachet (1) in the medicament container (3) while its lid (4) is removed, and the addition of a solvent (5).

FIGS. 3a-b show embodiments of the invention, in which the disposal device material (2) is embedded in the bottom of the medicament container (3). FIG. 3a shows a medicament container (3) with its lid (4) and disposal device material (2) embedded in the bottom of the medicament container (3). FIG. 3b shows a medicament container (3) with disposal device material (2) embedded in the bottom of the medicament container (3), in which the lid (4) is removed and a solvent (5) is added.

FIGS. 4a-d show embodiments of the invention, in which the disposal device reservoir (1) with disposal device material is incorporated into the medicament container lid (4). FIG. 4a shows the medicament container (3) and the lid (4), which is dual functional, wherein the lid can be applied or affixed to the container in either direction. One side of the lid is meant to close the container and comprises an optional child resistant closure (6), and the other side of the lid is meant to close the container, comprises an optional child resistant closure (6), but also contains the disposal device reservoir (1). FIG. 4b shows a cut-away view of the lid (4), including the disposal device reservoir (1), the disposal device material (2), and an internal puncturing mechanism (7) meant to release the disposal device material into the vessel. The internal puncturing mechanism (7) has a flat end (8) and a pointed end (9). FIG. 4c shows a cut-away view of the medicament container (3) with unused medicament (10) that is closed with the lid (4) comprising the internal puncturing mechanism (7), in which the side of the lid with the disposal device reservoir (1) and material (2) is on the inside of the medicament container (3). This demonstrates how to prepare the disposal device incorporated into the medicament container for disposing unused medicament (10). FIG. 4d shows a cut-away view of the medicament container (3) with unused medicament (10) that is closed with the lid (4) comprising the internal puncturing mechanism (7), in which the puncturing mechanism (7) is in use. The pointed end (9) punctures the disposal device reservoir (1), thereby exposing the unused medicament (10) to the disposal device material (2).

### DETAILED DESCRIPTION

The present invention relates to a device for the disposal and/or neutralization of unused human or animal medicaments, such as drugs or medications. The present invention also relates to a method of disposing and/or neutralizing unused medicament, comprising mixing the unused medicament with a disposal device material and a solvent.

In certain aspects, the present invention is aimed at the deterrence of abuse or misuse of medicaments by a person other than the intended recipient, to remove and/or render unavailable the active agent(s) from medicaments that have a high rate of abuse, and/or to limit release of medicaments into the environment. Thus, the present invention enables improved safety and proper disposal of unused medicaments to reduce misuse of drugs and medications, and/or to lower the amount and/or rate of active agents that can be extracted or used when the medicament is acquired by an individual for whom the product has not been prescribed or intended. By destroying the medicament and/or reducing the amount of the extractable active agent, those misusing the product may be prevented from experiencing the euphoric, pleasurable, reinforcing, rewarding, mood altering, and/or toxic effects of the active agent. And by reducing the extraction rate or usability, those misusing the product may be deterred from continuing because of the length of time required for the extraction process.

### DEFINITIONS

The term “disposal device material” refers to an aspect of the disposal device of the invention that can render a medicament unusable according to the use instructions and/or unavailable for extraction for abuse. The disposal device material comprises one or more disposal device agents and, optionally, other components that may affect the use of the medicaments.

The term “disposal device agent” refers to an agent that interacts with a solvent to gel, form a mass, increase viscosity, etc.

The term “disposal device reservoir” refers to anything that holds the disposal device material.

The term “medicament” refers to any product or therapy that contains one or more active agents. A medicament may be a prescription or non-prescription drug product, or it may be an alternative therapy (e.g., vitamin or nutritional supplement).

The term “medicament container” refers to the container or enclosure in which the medicament is provided (e.g., sold, transported, etc.).

The term “abusable drug” refers to any active agent that is known to have the potential for abuse. An example of an abusable drug is an opioid agonist.

The term “misuse” refers to the use of a medicament in a manner that is not consistent with the use information. “Misuse” includes administering the medicament at an undirected (e.g., unprescribed) dosage or frequency; in an undirected route of administration or combination with other treatments; or for an undirected purpose or duration. “Misuse” also includes administration after the medicament is expired, or accidental use.

The term “accidental use” refers to the use of a medicament without intent. Examples include administering the medicament while believing it was another product, or administering the medicament inadvertently (e.g., unintended exposure to an inhalant or puncture by a syringe), or ingesting the medicament without appreciating what it is (e.g., a child swallowing a pill believing it is candy).

The term “use information” refers to information that directs the use of the medicament, such as prescribing information or directions.

The term “tampered” or “tampering” refers to any manipulation by physical, mechanical, thermal and/or chemical means that changes the physical properties of the dosage form, for example, to liberate the active agent for immediate release if it is in a sustained release formulation, or to make the active agent available for inappropriate use, such as use by a route of administration other than that which is approved. The tampering can be, for example, by means of crushing, shearing, grinding, mechanical extraction, solvent extraction, solvent immersion, combustion, heating or any combination thereof.

The term “abuse” in the context of, for example, “medicament abuse” or “drug abuse”, refers to use, or the effects thereof: (i) in quantities or by methods and routes of administration that do not conform to standard medical practice; (ii) outside the scope of specific instructions for use provided by a qualified medical professional; (iii) outside the supervision of a qualified medical professional; (iv) outside the approved instructions on proper use provided by the medicament's legal manufacturer; (v) which is not in specifically approved dosage formulations for medical use; (vi) where there is an intense desire for and efforts to procure same; (vii) with evidence of compulsive use; (viii) through acquisition by manipulation of the medical system, including falsification of medical history, symptom intensity, disease severity, patient identity, doctor shopping, prescription forgeries; (ix) where there is impaired control over use; (x) despite harm; (xi) by procurement from non-medical sources; (xii) by others through sale or diversion by the individual into the non-medical supply chain; and/or (xiii) for medically unapproved or unintended mood altering purposes. Abuse can be in the context of intermittent use, recreational use and chronic use, including drug combinations.

The terms “abuse resistant,” “abuse deterrent,” and “deter abuse” may be used interchangeably and include formulations and methods that resist, deter, discourage, diminish, delay and/or frustrate (i) the intentional, unintentional or accidental physical manipulation or tampering of the dosage form (e.g., crushing, shearing, grinding, chewing, dissolving, melting, needle aspiration, inhalation, insufflation, extraction by mechanical, thermal and chemical means, and/or filtration); (ii) the intentional, unintentional or accidental use or misuse of the dosage form outside the scope of specific instructions for use provided by a qualified medical professional, outside the supervision of a qualified medical professional and outside the approved instructions on proper use provided by the medicament's legal manufacturer (e.g., intravenous use, intranasal use, inhalational use and oral ingestion to provide high peak concentrations); (iii) the intentional, unintentional or accidental conversion of an extended release dosage formulation into a more immediate release formulation; (iv) the intentional and iatrogenic increase in physical and psychic effects sought by recreational drug users, addicts, and patients with pain who have an addiction disorder; (v) the attempts at surreptitious administration of the dosage form to a third party (e.g., in a beverage); (vi) the attempts to procure the dosage form by manipulation of the medical system and from non-medical sources; (vii) the sale or diversion of the dosage form into the non-medical supply chain and for medically unapproved or unintended mood altering purposes; and/or (viii) the unintentional or accidental attempts at otherwise changing the physical, pharmaceutical, pharmacological and/or medical properties of the dosage form from what was intended by the manufacturer.

The term “neutralization” or other forms of the term such as “neutralize” or “neutralizing” refers to degrading the medicament so that it cannot be used or abused, and/or diminishing the medicament's physiological and/or neurological effect.

### Disposal Device

The disposal device may comprise a disposal device material that can render a medicament unusable according to the use instructions and/or unavailable for extraction for abuse and/or unavailable for leaching into water supplies or landfills. The disposal device material, when combined with a solvent, can render the medicament no longer available for administration as directed in the use information, misuse or accidental use, or abuse. As a result, the disposal device material will deter use of the medicament by an individual for whom the medicament was not intended, such as prevent an abuser from modifying the product to be used in a manner that is not consistent with the prescribing information or instructions for use.

The disposal device material comprises one or more disposal device agents that, when combined with the solvent, may form a gel or mass, i.e., a substance of high viscosity so that it is not easily pourable, transferable, mixable or vaporizable, and generally remains in the container in which it is formed. The disposal device material may comprise other components that affect the use of the medicament. A general example of the disposal device agent and components that may be in the disposal device material is provided in Table 1:

TABLE 1
Example of a disposal device material
according to the present invention.

| Agents/Components | Function |
|---|---|
| Agent: superabsorbent polymers | Encapsulating and dispersant agent |
| | that can limit physical and |
| | functional access to drug |
| Component: non-specific | Reactive metal such as activated |
| catalytic component | alumina, etc., or other agent |
| | that can induce surface catalysis |
| | of organic compounds |
| Component: specific | Stable protein or other binder |
| catalytic component | that specifically degrades the drug |

The disposal device may also comprise a disposal device reservoir that holds or houses the disposal device material.

Once the disposal device is implemented and the gel/mass is formed of the medicament, subjecting the gel/mass to tampering, such as by crushing the gel/mass and/or using aqueous or alcoholic solvents to extract the active agent for filtering and/or vaporizing the medicament for inhalation, may result in a gel/mass material that is not filterable or that has a filter rate that is diminished to an appreciable extent or that is prevented from being vaporized. In certain embodiments, the mechanism of action of the disposal device material may involve intermolecular interactions of the disposal device material with the active agent of the medicament, thereby preventing the active agent from passing through the filtration system or being vaporized.

Disposal Device Material

The disposal device material comprises one or more disposal device agents. The one or more disposal device agents may have both hydrophilic and hydrophobic properties, such that the agent forms a mass after mixing with water over a suitable period of time. This mass would then deter, slow, or even prevent, to an appreciable degree the extraction of the active agent of the medicament by aqueous or alcoholic means or vaporization.

The one or more disposal device agents may include one or more gelling or massing or viscosity increasing agents. An example of a massing agent is calcium sulfate, which can also neutralize the drug through its pH and chemical action.

In certain embodiments, the one or more disposal device agents can be a hydrogel. Hydrogels come in a variety of forms, such as: super absorbent hydrogels, super porous hydrogels, super porous hydrogel composites, and super porous hydrogel hybrids, etc.¹⁰ ¹⁰ See H. Omidian et al., Advances in Superporous Hydrogels, 102 J. CONTROL. RELEASE 3 (2005).

Other examples of disposal device agents may include, but are not limited to: long-chain carboxylic acids, long-chain carboxylic acid esters, long-chain carboxylic acid alcohols, and/or combinations thereof. An example of a long-chain carboxylic acid alcohol is cetearyl alcohol.

The long chain carboxylic acids may generally contain from 6 to 30 carbon atoms and preferably contains at least 12 carbon atoms, most preferably 12 to 22 carbon atoms. In some cases this carbon chain may be fully saturated and unbranched, while others contain one or more double bonds, 3-carbon rings or hydroxyl groups. Examples of saturated straight chain acids are n-dodecanoic acid, n-tetradecanoic acid, n-hexadecanoic acid, caproic acid, caprylic acid, capric acid, lauric acid, myristic acid, palmitic acid, stearic acid, arachidic acid, behenic acid, montanic acid and melissic acid. The long chain carboxylic acids for use in the present invention may also include unsaturated monoolefinic straight chain monocarboxylic acids, which include, but are not limited to oleic acid, gadoleic acid and erucic acid. Also useful are unsaturated (polyolefinic) straight chain monocarboxylic acids. Examples of these are linoleic acid, linolenic acid, arachidonic acid and behenolic acid. Useful branched acids include, for example, diacetyl tartaric acid. Combinations of the straight chain acids are also contemplated.

Examples of long chain carboxylic acid esters include, but are not limited to, those from the group of: glyceryl monostearates; glyceryl monopalmitates; mixtures of glyceryl monostearate and glyceryl monopalmitate (Myvaplex 600, Eastman Fine Chemical Company); glyceryl monolinoleate; glyceryl monooleate; mixtures of glyceryl monopalmitate, glyceryl monostearate, glyceryl monooleate and glyceryl monolinoleate (Myverol 18-92, Eastman Fine Chemical Company); glyceryl monolinolenate; glyceryl monogadoleate; mixtures of glyceryl monopalmitate, glyceryl monostearate, glyceryl monooleate, glyceryl monolinoleate, glyceryl monolinolenate and glyceryl monogadoleate (Myverol 18-99, Eastman Fine Chemical Company); acetylated glycerides such as distilled acetylated monoglycerides (Myvacet 5-07, 7-07 and 9-45, Eastman Fine Chemical Company); mixtures of propylene glycol monoesters, distilled monoglycerides, sodium stearoyl lactylate and silicon dioxide (Myvatex TL, Eastman Fine Chemical Company); mixtures of propylene glycol monoesters, distilled monoglycerides, sodium stearoyl lactylate and silicon dioxide (Myvatex TL, Eastman Fine Chemical Company) d-alpha tocopherol polyethylene glycol 1000 succinate (Vitamin E TPGS, Eastman Chemical Company); mixtures of mono- and di-glyceride esters such as Atmul-84 (Humko Chemical Division of Witco Chemical); calcium stearoyl lactylate; ethoxylated mono- and di-glycerides; lactated mono- and diglycerides; lactylate carboxylic acid ester of glycerol and propylene glycol; lactylic esters of long chain carboxylic acids; polyglycerol esters of long chain carboxylic acids, propylene glycol mono- and di-esters of long chain carboxylic acids; sodium stearoyl lactylate; sorbitan monostearate; sorbitan monooleate; other sorbitan esters of long chain carboxylic acids; succinylated monoglycerides; stearyl monoglyceryl citrate; stearyl heptanoate; cetyl esters of waxes; stearyl octanoate; C₁₀-C₃₀ cholesterol/lavosterol esters; and sucrose long chain carboxylic acid esters. Combinations of the long chain carboxylic acid esters are also contemplated.

In certain embodiments, a disposal device agent may be selected from the group consisting of carbomers (Carbopol 71G, 971P and 974P), xanthan gum, sodium alginate (Keltone), Polyox, and mixtures thereof.

In certain embodiments, a disposal device agent may comprise polymeric or non-polymeric composite materials. In some embodiments, the disposal device agent may comprise plaster materials that may be known as “plaster of Paris” such as, but not limited to gypsum, lime, and cement. With the addition of water, plaster gives off heat, which may aid in dissolving a capsule or tablet if present, or furthermore destroy the drug of interest. In some embodiments, the disposal device agent may comprise dental impression materials.¹¹ One advantage in using this type of material is in the length of setting time; there is ample time for the tablet or capsule to dissolve prior to massing or gelling. In certain embodiments, the disposal device agent may comprise alginate materials. Various types of alginate mixtures are available. Alginates, which are irreversible hydrocolloids, can be formed by mixing alginic acid with calcium salt, e.g., calcium sulfate or plaster. Additional ingredients can be added to the alginate colloid as hardeners, such as diatomaceous earth. Also, the alginates can be mixed with glycol to prevent powders from being inhaled as the powder is dispensed from the disposal device reservoir to another container. ¹¹ See B. Doubleday, Impression Materials, 25 BR. J. ORTHOD. 133 (1998).

In other embodiments, a disposal device agent may comprise silicone materials, dental plaster material (brittle ceramic material), zinc oxide Eugenol (brittle ceramic material) and agar.

Various examples of marketed polymeric products for use as a disposal device agent are Aqua Keep® super absorbent polymer for diaper use, SumitomorSeika; Water Lock®, super absorbent polymers, Grain Processing Corporation of Muscatine, Iowa.; Waste management or Diaper filling material polymer, a highly absorbent polymer with cross linked polyacrylate, such as Waste Lock®, various grades from M² Polymer Technologies, Inc.

As discussed, the disposal device agents comprise one or more gelling or massing or viscosity increasing agents. Particular examples of the viscosities that can be achieved when various disposal device agents are mixed with a solvent are provided in Table 2.

TABLE 2
Examples of viscosities resulting from mixing
disposal device agents with a solvent.

| Disposal Device Material | Viscosity (cP)* |
|---|---|
| HPMC 2% w/v in water | 2.4-120,000 |
| Na Carboxymethylcellulose 1% w/v in water | 5-13,000 |
| Hydropropylcellulose 2% w/v in water | 150-6500 |
| Hydroxyethylcellulose 2% w/v in water | 2-20,000 |
| Methylcellulose 2% w/v in water | 5-75,000 |
| Xanthan Gum 1% w/v in water | 1200-1600 |

*The viscosity numbers, presented in units of centipoise (cP), are general numbers and are affected by different characteristics of the disposal device agents, most importantly the molecular weights of the polymers. The concentration of the polymer in water can be adjusted to increase viscosity.

Potential gelling or massing agents for use as the disposal device agent can also, but are not required to, perform one or more of the following actions:
destroy or dissolve a capsule or tablet;
oxidize the active ingredient, and other actions such as hydrolysis;
reduce the waste disposal costs by expanding in volume by less than 1%;
will not release trapped contaminants if solute evaporation occurs;
have a strong ion exchange capability allowing for binding;
will not release free liquids when subject to freeze-thaw cycles;
will not allow for vaporization of medicaments.

In additional embodiments, the disposal device material may comprise other components that help render the medicament unusable or unavailable for extraction or abuse. For instance, the disposal device material may comprise one or more components that interact with the medicament by neutralizing the medicament, i.e., by degrading the medicament so that it cannot be used or abused, or by diminishing the medicament's physiological and/or neurological effects. Such a neutralizing component may perform an acidifying, nitrosylating, decomposition, free-radical forming, or catalytic action. Examples of these components include, but are not limited to, hydrochloric acid, boric acid, ammonium hydroxide, acetic acid, citric acid, lactic acid, ammonium carbonate, sodium bicarbonate, sodium bisulfate, sodium carbonate, sodium hydroxide, trolamine, potassium hydroxide, magnesium hydroxide, glutamate buffer, phosphate buffer, carboxymethyl guar, and carboxymethylhydroxypropyl guar.

In some embodiments, the disposal device material may comprise one or more components that provide its own therapeutic effect upon administration, such as neutralizing or antagonizing the therapeutic effect of the medicament. For example, such neutralizing or antagonizing components may block or inhibit or override the therapeutic action of the medicament.

For cases when the medicament comprises an opioid, the disposal device material may comprise one or more opioid inverse agonists. The opioid inverse agonist may be non-selective such as, but not limited to, naloxone. Naloxone is often used to counter the effects of opiate overdose, for example heroin or morphine overdose. Naloxone is particularly used to counteract life-threatening depression of the central nervous system and respiratory system. In general, naloxone may be present in the disposal device material in amounts ranging from about 1 mg to about 50 mg. Other materials may be present in other amounts as necessary to be effective.

The opioid inverse agonist may be selective, for example, having a high affinity for particular opioid receptors, such as a μ-opioid receptor, α-opioid receptor, K-opioid receptor, or δ-opioid receptor.

Alternatively, the disposal device material may comprise both non-selective and selective opioid inverse agonists.

In other embodiments, the disposal device material may comprise one or more opioid antagonists. The opioid antagonist may be non-selective such as, but not limited to, naltrexone, which is often used to help patients overcome opioid addiction by blocking the opioids' euphoric effects. Alternatively, the opioid antagonist may be selective such as, but not limited to cyprodime, which is a selective μ-opioid receptor antagonist; naltrindole, which is a selective δ-opioid receptor antagonist; and norbinaltorphimine, which is a selective κ-opioid receptor antagonist.

In certain embodiments, the disposal device material may comprise a combination of non-selective and selective opioid inverse agonists or antagonists.

The disposal device material may further comprise other components such as binders, alkalining agents, disintegrants, dispersing agents, hardening agents, effervescent agents, and/or bittering agents that are co-formulated or combined with the disposal device agent.

The other components may be co-formulated with the one or more disposal device agents, such as in the same powder, bead, etc.; or, the other components may be combined with the one or more disposal device agents, such as in separate powder, beads, etc.

For example, the disposal device material may further comprise a binder, such as, but not limited to, polyvinylpyrrolidone (PVP), or its derivatives, microcrystalline cellulose (Avicel, FMC Corporation) (MCC), HPMC, hydroxyethylcellulose, hydroxypropylcellulose, and other cellulose derivatives. In some embodiments, the binder may comprise a hydrophobic oil. Examples of hydrophobic oils include, but are not limited to, a wax, oil, lipid, fatty acids, cholesterol, or triglyceride. In certain embodiments, the binder may be selected from Transcutol, PEG-400 and Cremophor (Castor Oil). The binder may also be activated charcoal.

In some embodiments, the disposal device material may further comprise an alkalining agent. Alkalining agents include, but are not limited to, polyplasdone XL, talc, meglumine, NaHCO₃, and PVP. The alkalining agents may be in the form of a powder, pellet, bead, beadlet, granule, or the like. In some embodiments, the alkalining agents may be present in a particular ratio to the disposal device agent, such as about 30:70 w/w to about 70:30 w/w.

Other excipients that may be combined with the one or more disposal device agents include, but are not limited to, lactose, NaHCO₃, and magnesium stearate.

The disposal device material may also further comprise a hardening agent. Examples of hardening agents are dental cements that are known in the art.

Moreover, the disposal device material may further comprise an effervescent agent, which in certain embodiments is a combination of an acid with a carbonate or bicarbonate material that reacts rapidly in the presence of water by releasing carbon dioxide or other activator gas release systems. The effervescent agent may be combined with the one or more disposal device agents as a loose powder, or may be co-formulated with the one or more disposal device agents as granulations or beads. In certain embodiments, the effervescent agent may be used when the one or more disposal device agents are in the form of coated beadlets. The effervescent agent can act to disperse the coated disposal device agent beadlets once they are mixed with the solvent. The disposal device material is then stirred up in the resulting solution, which creates a better dispersion of the disposal device agent around the dissolved or partially dissolved prescription product. In certain embodiments, the coating of the disposal device agent beadlets can be dissolved after a slight delay once the effervescent agent has created a dispersion, allowing the one or more disposal device agents to gel with increased contact with the medicament.

The disposal device material may further comprise a bittering agent. An example of a bittering agent is denatonium, such as denatonium benzoate (Bitrex®) or denatonium saccharide.

In certain embodiments of the invention, a lipophilic polyelectrolyte gel can be included with the gelling or massing material. Lipophilic polyelectrolyte gels may be super-absorbent polymers for nonpolar organic solvents.¹² These polymers can be from the group of polymers that are polyelectrolyte gels bearing tetra-alkylammonium tetraphenylborate as a lipophilic and bulky ionic group swell in some nonpolar organic solvents up to 500 times their dry size. Dissociation of the ionic groups even in low-dielectric media (3<∈<10) enhances the swelling ability by expansion of the polymer networks. This expands the potential of polyelectrolytes that have been used only in aqueous solutions or highly polar solvents, and provides soft materials that swell in a variety of media. These materials could act as a further deterrent to abuse of a medicament combining with aqueous polymeric material such that on future/subsequent extraction of the active agent of the medicament from the solid after disposal, the active agent would then further be absorbed in an organic extraction material. ¹² See T. Ono et al., Lipophilic Polyelectrolyte Gels as Super-Absorbent Polymers for Nonpolar Organic Solvents, 6 NAT. MATER. 429 (2007).

The disposal device material may further comprise excipients such as diluents, disintegrants, glidants, lubricants, oxidizing agents, and combinations thereof. Particular examples of excipients include, but are not limited to, MCC, lactose, magnesium stearate, NaHCO₃, silicon dioxide, sodium carboxymethyl-cellulose, starch, polyethylene glycol (PEG), polysorbates, hydroxypropyl cellulose, povidone, artelinic acid, fumed silica, fumed titanium dioxide, benzoyl peroxide, carbamide peroxide, and the like.

Disposal Device Reservoir

The disposal device may comprise a disposal device reservoir that holds or houses the disposal device material. The disposal device reservoir may be independent and separate from the medicament container or may be incorporated into the medicament container, such as within, or attached to, the medicament container walls, bottom, and/or lid.

The disposal device reservoir may serve different roles in the use of the disposal device. For example, the disposal device reservoir may house the disposal device material, such that, during implementation, the material may be removed, in full or in part, from the disposal device reservoir and may be added, perhaps along with a solvent, to the medicament container or to a separate container; or, during implementation, the unused medicament may be added, perhaps along with a solvent, to the disposal device reservoir. Alternatively, the disposal device reservoir may introduce the disposal device material to the unused medicament, such that, during implementation, the disposal device reservoir is added to the medicament container or to a separate container in which the unused medicament is placed; the disposal device reservoir may then dissolve, such as upon addition of a solvent, to expose the disposal device material to the unused medicament. Or, the disposal device reservoir may be used to separate the disposal device material from the unused medicament until implementation of the disposal device; for instance, the disposal device reservoir may be a membrane that separates the material from the medicament, and, during implementation, a solvent may be added to dissolve or breach the membrane to thereby expose the medicament to the material. A further application is to place the disposal device reservoir in the medicament container's lid or cap or within the medicament container's wall or bottom, so that it can be dispensed into the medicament container.

The disposal device reservoir can be in the form of a sachet, packet, straw, membrane enclosure, or other suitable container from which to hold or house the disposal device material. The disposal device reservoir can optionally be made as a re-sealable unit. The disposal device reservoir can also be in the form of a blister pouch or multiple pouches fused to the internal surface of the medicament container or the container's cap or lid; or the disposal device reservoir may be a chamber within one or more walls or bottom of the medicament container or the container's cap or lid. The disposal device reservoir may be a suitable container into which disposal device material can be transferred to for the purposes of mixing the unused medicament with the disposal device material.

The sachet, packet, straw or other suitable container can be square, round, rectangular or other suitable shape for fitting into a medicament container. The blister pouch or pouches may be polygon, ovoid, serpentine, other suitable shape, or combination of various shapes. The shape of the blister pouch or pouches may be incidental or may confer functionality in the release of the disposal device material.

The size of the disposal device reservoir, system and its contents can be scaled to accommodate a 30-, 60- or 90-day supply of the medicament contemplated for disposal. Typical sizes of pharmacy dispensing bottles can range from 30 ml to 100 ml. The disposal device, including the reservoir, can be scaled according to the pharmacy container size in anticipation of the volume of water to be added to the bottle. Thus, for a smaller quantity of medicament dispensed, a smaller unit of the disposal device may be dispensed; with a larger quantity of the medicament dispensed, a larger unit, or multiple units of the disposal device may be dispensed.

The disposal device reservoir in the form of blister pouch or pouches fused with the medicament container may be positioned within the medicament container or container cap so as to accommodate various fill levels of the medicament container.

The pharmacist may dispense the medicament, and depending on the size of medicament container, the pharmacist can then select 1×, 2×, 3× of the disposal device to be co-dispensed. Alternatively, the pharmacist may select the medicament container fabricated with the disposal device reservoir that accommodates the fill level of dispensed medicament.

The disposal device reservoir can be manufactured by methods known to those skilled in the art, and be made from standard paper, plastic, polymers, etc. or specialty materials that confer functionality.

The disposal device reservoir can be made of material which dissolves upon contact with water or other solvent, thereby releasing the contents of the disposal device reservoir into the medicament container or a separate container of unused medicament. Examples of materials used for the disposal device reservoir are gelatin, ethyl cellulose, and other materials that are soluble on contact with water or partially hydrophilic solutions. In the case of blister pouches fused with the medicament container, multiple pouches may be made of various materials to affect a sequence of disposal device materials.

In other embodiments, the disposal device reservoir can be made of materials that are designed for delayed dissolution upon contact with water or other solvent.

Alternatively, in instances in which the unused medicament is to be added to the disposal device reservoir, the disposal device reservoir can be made of plastic, waxed board like a milk carton, or be an other suitable container capable of holding both liquid and solid materials.

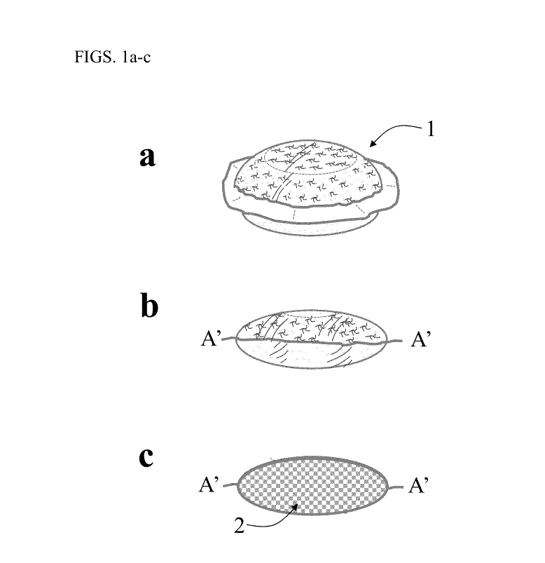

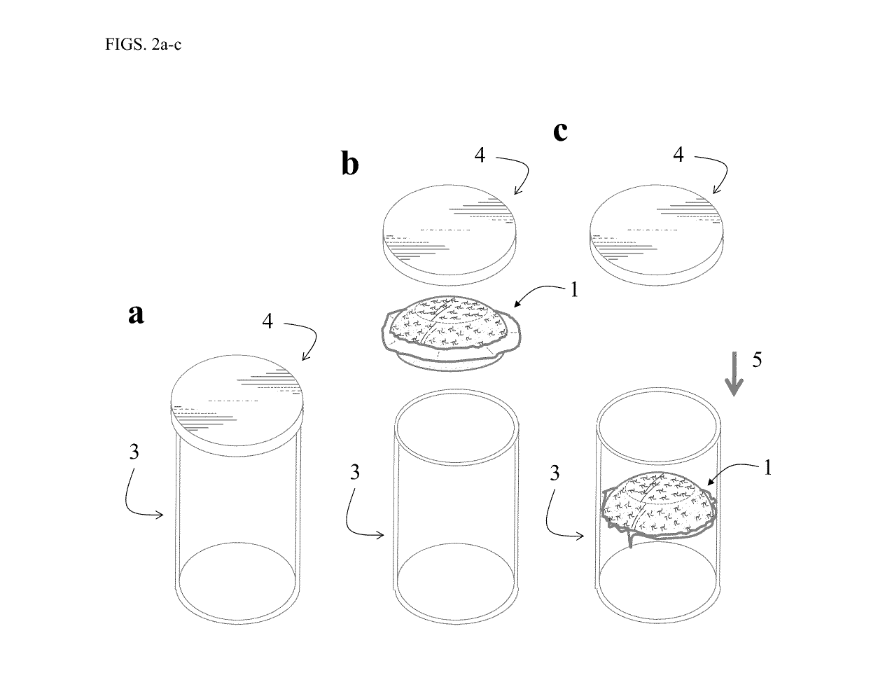

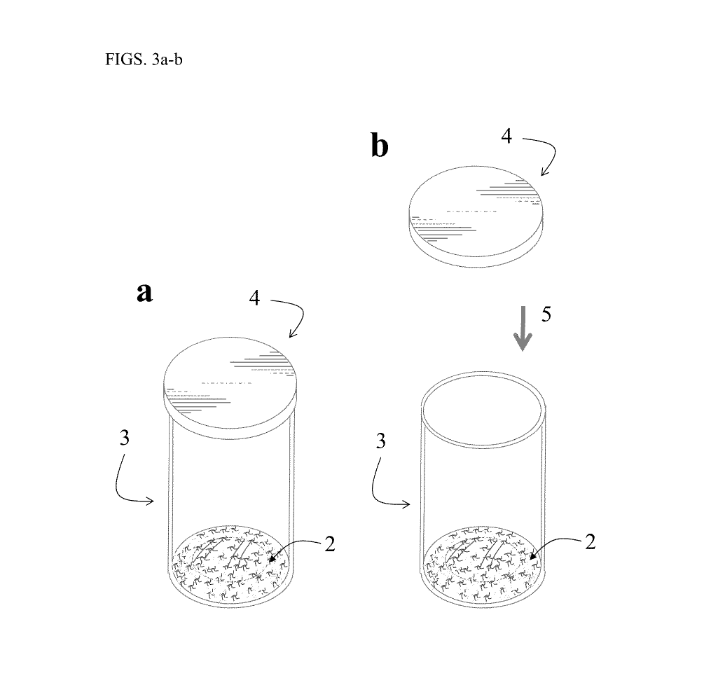

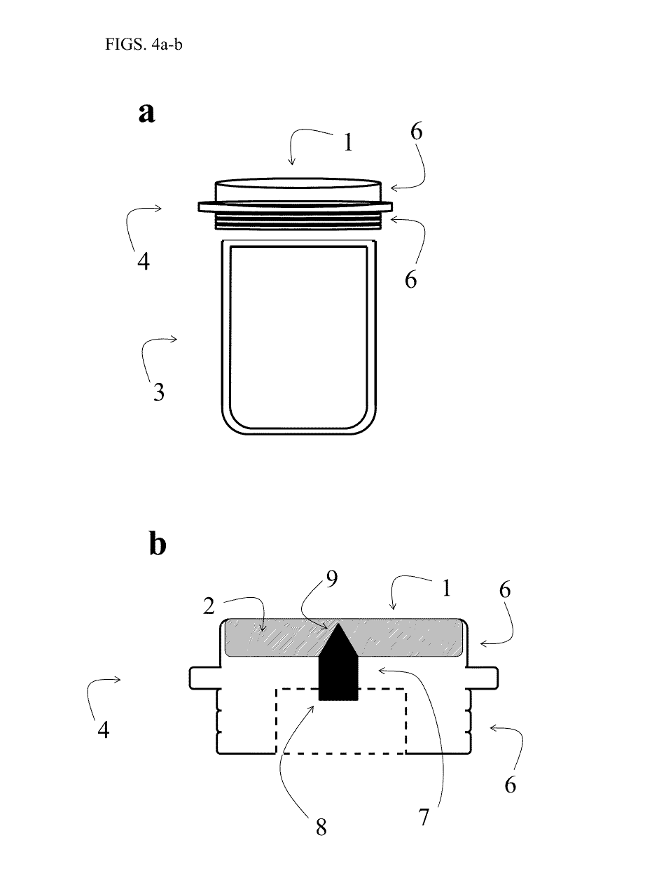

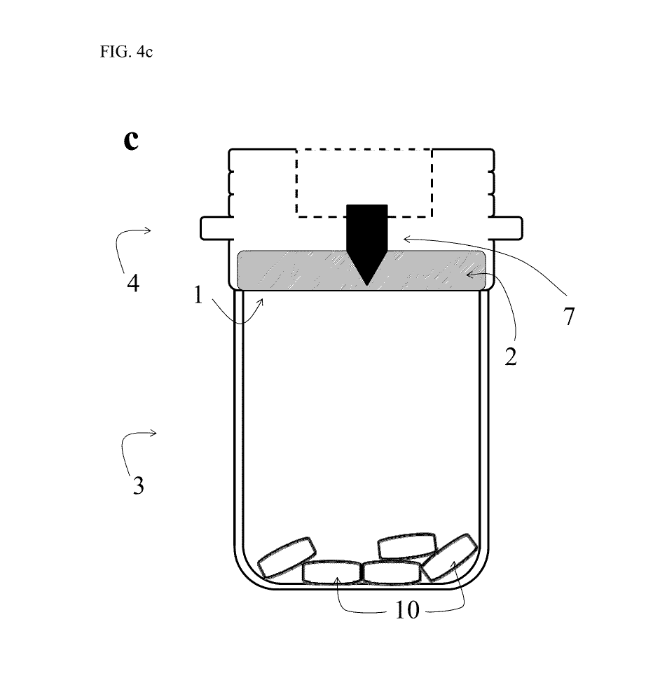

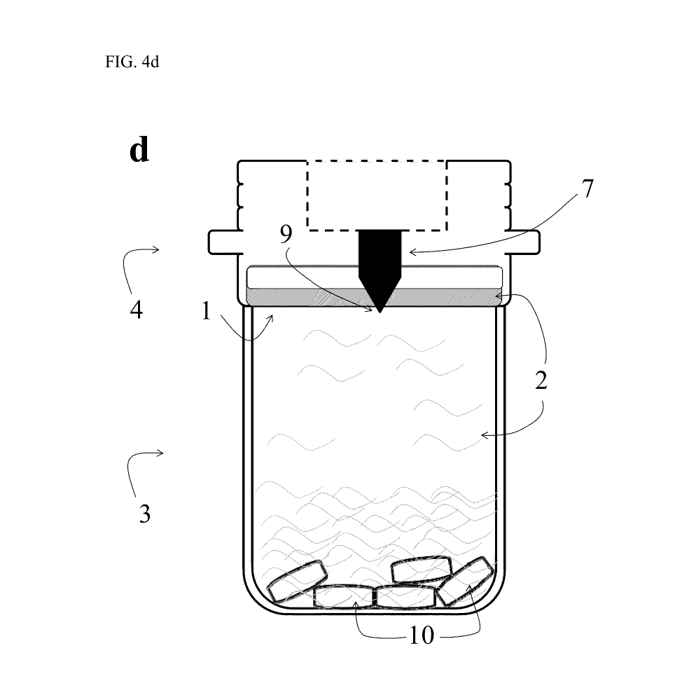

FIGS. 1a-c show an embodiment of a sachet (1) in accordance with the invention, in which the sachet can be added to a drug vial. As shown, the disposal device material (2) is throughout the inside of the sachet. FIGS. 3a-b show an embodiment in accordance with the invention, in which the disposal device reservoir harboring the disposal device material (2) is embedded in the bottom of the medicament container (3). FIGS. 4a-d show an embodiment in accordance with the invention, in which the disposal device reservoir (1) harboring the disposal device material (2) is a part of the lid (4) of the medicament container (3).

Method of Disposing and/or Neutralizing of Unused Prescription Product

The present invention relates to a method of disposing and/or neutralizing unused medicament, comprising mixing the unused medicament with a disposal device material and a solvent, such as a hydrophilic diluent. In some embodiments, the solvent is water, alcohol, vinegar, or bleach. In certain embodiments in which the medicament is an injectable, solution, suspension, or other liquid dosage form, the solvent may comprise, at least in part, the medicament itself.

In embodiments of the invention, the unused medicament and the disposal device material, as well as the solvent if a solvent is added, may be mixed, such as by an instrument or mixing device known in the art, or by shaking or swirling the contents of the medicament container or the separate container.

In some embodiments, the disposal device material may be housed in the disposal device reservoir and, during implementation, the disposal device material is removed from the disposal device reservoir and is added to the medicament container or lid or to a separate container. The solvent may also be added to the medicament container or the separate container. In further embodiments, the unused medicament and disposal device material, and the solvent (if a solvent is added), may be mixed.

In certain embodiments, the disposal device material may be housed in the disposal device reservoir and, during implementation, the unused medicament may be added to the disposal device reservoir. The solvent may also be added to the disposal device reservoir. In some embodiments, the unused medicament and disposal device material, and the solvent (if a solvent is added), may be mixed.

In embodiments of the invention, the disposal device material may be housed in the disposal device reservoir and, during implementation, the disposal device reservoir may be added to the medicament container or to a separate container that has the unused medicament. The solvent may also be added to the medicament container or the separate container. In some embodiments, the unused medicament and disposal device material, and the solvent (if a solvent is added), may be mixed.

As an example, FIGS. 2a-c depict embodiments in which the disposal device reservoir is a sachet (1), and the sachet is placed into the medicament container (3). A solvent (5) can then be added to the medicament container to mix with the sachet and any unused medicament in the medicament container. The medicament container may be covered with a lid (4) and then mixed.

In further embodiments, the disposal device reservoir may be a part of the medicament container. For example, the disposal device reservoir may be attached to the inside of the medicament container, such as on the bottom, the side walls, or the lid of the medicament container. Or, the disposal device reservoir may be incorporated or embedded into the bottom, the side walls, or the lid of the medicament container. In some embodiments, the disposal device reservoir may be in the form of, for instance, a blister or rib, and may comprise a membrane that prevents the disposal device material from contacting the medicament unless it is breached or dissolved in full or in part. Alternatively, the disposal device reservoir may be mechanically altered, such as a removal or movement of a portion of the disposal device reservoir, which allows the disposal device material to contact the medicament; an example is if the disposal device reservoir is in the form of a chamber, in which a wall of the chamber, or a portion thereof, can be moved or removed.

For instance, FIGS. 3a-b depict embodiments in which the disposal device reservoir (1) is embedded with the disposal device material (2) in the bottom of the medicament container (3). A solvent (5) can then be added to the medicament container. The medicament container may then be covered with a lid (4) and then mixed.

FIGS. 4a-d depict embodiments in which the disposal device reservoir (1) with the disposal device material (2) is embedded within the lid (4) of the medicament container (3). As shown in FIG. 4b, the lid may be dual functional, wherein one side of the lid comprises a child resistant closure (6), and the other side of the lid is also a child resistant closure (6) comprising the disposal device reservoir (1). While the medicament is still in normal use, the side of the lid with the child resistant closure may be used to close the medicament container. When unused medicament is to be disposed, the side of the lid with the disposal device reservoir (1) may be used to close the medicament container as shown in FIG. 4c. The medicament container, which may comprise a membrane such as a foil sheet, may be punctured in order to allow the disposal device material to contact the unused medicament (10). The membrane may be breached with an internal puncturing mechanism (7) as illustrated in FIG. 4b, whereby a flat end (8) of the puncturing mechanism is accessible on the side of the lid with the child resistant closure, and pushing on the flat end of the puncturing mechanism would allow the pointed end (9) of the puncturing mechanism to pierce the membrane of the disposal device reservoir, as shown in FIG. 4d. In some embodiments, the membrane of the disposal device reservoir may be pierced with other means known in the art, including simply piercing the membrane with any sharp or pointed object. In certain embodiments, the membrane may be perforated.

The time for gelling or massing can vary depending on the disposal device material. For example, for a fast set alginate, the time to gel may be about 45 sec, to about 1¼ min; for a normal set alginate, the time to gel may be about 60 sec. to about 2 min.

When the medicament is dispensed, e.g., sold, by a pharmacist or vender, the disposal device may also be dispensed concurrently, before or thereafter. Any leftover or unused portion of the medicament not being used by the person for whom the medicament was prescribed can be mixed with the disposal device to render the medicament unusable according to the prescribing instructions or use instructions, or to render the medicament otherwise unavailable for unintended uses/abuse.

For an oral dosage form such as, but not limited to, a tablet, capsule, or other solid oral product, once the patient has completed the course of therapy, the disposal device material may be added to the medicament container having any unused portion of the medicament, along with the solvent. The medicament container can then be deposited in the household, industrial or other suitable waste container for disposal. Alternatively, the unused medicament can be added to the disposal device reservoir, along with the solvent. In other embodiments, the disposal device material, the solvent, and the unused medicament may be mixed in a separate container that is neither the disposal device reservoir nor the medicament container.

If the medicament is in the form of an injectable, solution, suspension, or other liquid dosage form, any remaining solution (for an injectable, the remaining solution would have to be removed from its medicament container, e.g., vial) may be added to the disposal device reservoir. A solvent may be added, if necessary.

Those who use medicaments in the form of a patch are often directed to flush the patch down the toilet for disposal. As an alternative, the patch can be placed in a vessel (e.g., jar, vial, etc.) with the disposal device material, or placed in a vessel with the disposal device reservoir having the disposal device material. The vessel can then be filled with water. This is especially useful for water soluble active containing products. Inhalants may similarly be disposed of using the present disposal device.

The disposal device can be utilized with any substance that may be harmful or toxic to ingest or otherwise be administered. For instance, the disposal device may be utilized with one or more medicaments, including pharmaceutical products such as prescription drugs and OTC drugs, or alternative therapies. Pharmaceutical products that may be used with the disposal device may include, but are not limited to, anti-infectives, such as ambecides, aminoglycosides, anthelimintics, antifungals, antimalarial agents, antituberculosis agents, antiviral agents, cephalosporins, penicillins, quinolones, sulfonamides, and tetracyclines; antineoplastics, such as alkylating agents, antimetabolites, monoclonal antibodies, thalidomide and analogs, and vascular endothelial growth factor (VEGF) or VEGF receptor inhibitors; biologicals, such as antitoxins, antivenins, and recombinant human erythropoietins; cardiovascular agents, such as agents for hypertensive emergencies or pulmonary hypertension, antiadrenergic agents, antiarrhythmic agents, calcium channel blocking agents, catechcholamines, diuretics, vasodilators, or vasopressors; central nervous system agents, such as analgesics, anticonvulsants, anxiolytics, sedatives, hypnotics, cholinergic agonists, or muscle relaxants; chelating agents; coagulation modifiers, such as anticoagulants, antiplatelet agents, heparin antagonists, or platelet-stimulating agents; gastrointestinal agents, such as antacids, digestive enzymes, functional bowel disorder agents, gallstone solubilizing agents, gastrointestinal stimulants, laxatives, or proton pump inhibitors; genitourinary tract agents, such as impotence agents, tocolytic agents, urinary pH modifiers, or uterotonic agents; hormones, such as 5-alpha-reductase inhibitors, adrenal cortical steroids, antiandrogens, antidiuretic hormones, aromatase inhibitors, calcitonin, estrogen receptor antagonists, gonadotropin-releasing hormone antagonists, progesterone receptor modifiers, sex hormones, or thyroid drugs; immunologic agents, such as immunostimulants or immunosuppressive agents; metabolic agents, such as antidiabetic agents, antigout agents, antihyperlipidemic agents, bone resorption inhibitors, glucose elevating agents, or hysosomal enzymes; psychotherapetutic agents, such as antidepressants or antipsychotics; respiratory agents, such as antihistimines, bronchodilators, decongestants, expectorants, or respiratory inhalant products; smoking cessation agents; or topical agents, such as antiseptics, dermatological agents, germicides, nasal preparations, ophthalmic preparations, or vaginal preparations. In certain embodiments, the OTC drugs may be, for example, aspirin, Advil®, or Tylenol®. In some embodiments, the alternative therapies may be vitamins, nutritional supplements, natural/plant derived products, yeast and other fermented supplements, or other naturally derived therapeutic agents.

The disposal device can be utilized with one or more medicaments comprising abusable drugs such as schedule I, II, or III drugs. These drugs include opiate and opiate derivatives, hallucinogenic or psychedelic substances, depressants, and stimulants. Examples of abusable drugs include, but are not limited to, alfentanil, allylprodine, alphaprodine, anileridine, benzylmorphine, bezitramide, buprenorphine, butorphanol, clonitazene, codeine, cyclazocine, desomorphine, dextromoramide, dezocine, diampromide, dihydrocodeine, dihydroetorphine, dihydromorphine, dimenoxadol, dimepheptanol, dimethylthiambutene, dioxaphetyl butyrate, dipipanone, eptazocine, ethoheptazine, ethylmethylthiambutene, ethylmorphine, etonitazene, etorphine, fentanyl, heroin, hydrocodone, hydromorphone, hydroxypethidine, isomethadone, ketobemidone, levallorphan, levorphanol, levophenacylmorphan, lofentanil, meperidine, meptazinol, metazocine, methadone, metopon, morphine, myrophine, nalbuphine, narceine, nicomorphine, norlevorphanol, normethadone, nalorphine, normorphine, norpipanone, opium, oxycodone, oxymorphone, papavereturn, pentazocine, phenadoxone, phenomorphan, phenazocine, phenoperidine, piminodine, piritramide, propheptazine, promedol, properidine, propiram, propoxyphene, sufentanil, tramadol, tilidine, pharmaceutically acceptable salts thereof, prodrugs thereof, or combinations thereof.

The medicament may be water soluble drugs such as alfentanil, allylprodine, butorphanol, codeine, hydrocodone, hydromorphone, methadone, morphine, oxycodone, oxymorphone, pentazocine, tramadol and pharmaceutically acceptable salts thereof, prodrugs thereof, or combinations thereof. Other water soluble drugs include treatments for seizures, depression, fibromyalgia, migraine headaches and neuropathic pain such as gabapentin and analogs.

The medicament may also be highly potent drugs (such as morphine, alprazolam, and chlorpromazine) or drugs with strong side effect profiles such as chemotherapeutics (e.g., bendamustine, cisplatin, paclitaxel, and topotecan).

Examples of household animal medicaments that may benefit from a disposal device are flea and tick treatments.

The medicaments may be drugs that are past their expiration date.

The invention will now be further described by way of the following non-limiting examples, which further illustrate the invention; such examples are not intended, nor should they be interpreted, to limit the scope of the invention.

### EXAMPLES

### Example 1

### Screening Disposal Device Agents

Pharmaceutical excipients were screened for their ability to increase the viscosity of aqueous/alcoholic solutions and their potential use in disposal device material. Table 3 lists samples of disposal device agents tested with or without additional excipients, and qualitative results of these agents on solution viscosity.

The screening was performed using an extraction/filtration test. Briefly, 0.5 grams of powder (or crushed tablets in the case of Sample 004) were transferred into a container and 10 ml of water (tapped water at a temperature between 26 and 28° C.) was added. The mixtures were vigorously shaken until they were homogeneous, aided by a spatula when necessary to complete homogenization. The resulting suspensions were immediately filtered through a standard coffee filter (GK Connaisseur). Viscosity increase was evaluated by visual inspection, while filtration rate was evaluated by comparing the amount of liquid added to the filter to the amount of liquid recovered in the filtrate after 10 minutes of filtration.

TABLE 3
Disposal Device Agents Screening Study.

| Sample | Disposal Device Agents | Other Excipients | | Filtration After |
|---|---|---|---|---|
| No. | (% w/w on dry basis) | (% w/w on dry basis) | Initial Appearance | 10 minutes |
| 001 | Carbopol 71G (100%) | | Highly viscous | Unfilterable |
| | | | solution/gel | |
| 002 | Carbopol 71G (83%) | Lactose (17%) | Highly viscous | Unfilterable |
| | | | solution/gel | |
| 003 | Carbopol 71G (5%) | MCC* (54%) Lactose | Highly viscous | Unfilterable |
| | | (40%) NaHCO₃ (17%) | suspension | |
| | | Mg stearate (1%) | | |
| | | (powder) | | |
| 004 | Carbopol 71G (5%) | MCC (54%) Lactose | Highly viscous | Unfilterable |
| | | (40%) NaHCO₃ (17%) | suspension | |
| | | Mg stearate (1%) | | |
| | | (tablets)** | | |
| 005 | HPMC/HPC mix | | Slightly viscous | Filterable |
| | (Opadry) (100%) | | solution | |
| 006 | Plasdone K90 (100%) | | Slightly viscous | Filterable |
| | | | solution | |
| 007 | Polyox ™ (100%) | | Highly viscous | Unfilterable |
| | | | suspension | |
| 008 | Methocel E5 (100%) | | Slightly viscous | Filterable |
| | | | solution | |
| 009 | Carbopol 71G (20%) | MCC (80%) | Very viscous | Unfilterable |
| | | | suspension | |
| 010 | Carbopol 971P (20%) | MCC (80%) | Very viscous | Unfilterable |
| | | | suspension | |
| 011 | Carbopol 974P (20%) | MCC (80%) | Viscous suspension | Unfilterable |
| 012 | Polyox (20%) | MCC (80%) | Slightly viscous | Filterable |
| | | | solution | |
| 013 | Xanthan gum (20%) | MCC (80%) | Highly viscous | Unfilterable |
| | | | suspension | |
| 014 | Guar gum (20%) | MCC (80%) | Slightly viscous | Filtration rate |
| | | | suspension | decreased |
| 015 | Klucel EF (20%) | MCC (80%) | Non-viscous | Filterable |
| | | | suspension | |
| 016 | PEG 3350 (20%) | MCC (80%) | Non-viscous | Filterable |
| | | | suspension | |
| 017 | Eudragit RSPO (20%) | MCC (80%) | Slightly viscous | Filterable |
| | | | suspension | |
| 018 | Aerosil (20%) | MCC (80%) | Non-viscous | Filterable |
| | | | suspension | |
| 019 | Cellulose Gum (7L2P) | | Viscosity increases | Filtration rate |
| | (100%) | | with time | decreased with the |
| | | | | time |
| 020 | Cellulose Gum | | Viscosity increases | Filtration rate |
| | (C-5678) (100%) | | with time | decreased with the |
| | | | | time |
| 021 | HPMC AS-LG | | Non-viscous | Filterable |
| | (100%) | | suspension | |
| 022 | HPMC pH-5.0 | | Non-viscous | Filterable |
| | (100%) | | suspension | |
| 023 | Cellulose mix | | Non-viscous stable | Solid materials |
| | (Aquarius ®) (100%) | | suspension | passed through the |
| | | | | filter |
| 024 | Starch 1500 (100%) | | Slightly viscous | Filtration rate |
| | | | stable suspension | decreased |
| 025 | Sodium starch glycolate | | Slightly viscous | Filterable |
| | (100%) | | stable suspension | |
| 026 | Sodium Alginate | | Viscous cloudy | Filterable/cloudy |
| | (MANUGEL) (100%) | | liquid | liquid |
| 027 | Sodium Alginate | | Highly viscous | Unfilterable |
| | (KELTONE) (100%) | | cloudy liquid | |
| 028 | Sodium Alginate | MCC (80%) | Viscous cloudy | Filtration rate |
| | (KELTONE) (20%) | | liquid | decreased |
| 029 | Sodium Alginate | MCC (73%) | Viscous cloudy | Filtration rate |
| | (KELTONE) (18%) | Mg stearate (9%) | liquid | decreased |
| 030 | Carbopol 971P (10%) | MCC (90%) | Highly viscous | Unfilterable |
| | | | suspension | |

*MCC = microcrystalline cellulose.
**Tablets were produced from the powder blend of Sample No. 003 using a hydraulic press (Model C, Carver Inc.) with an 8 mm diameter standard concave tooling and a compression force 1750 lbf (14-15 kp).

As shown in Table 3, carbomers (Carbopol 71G, 971P and 974P), xanthan gum, sodium alginate (Keltone), Polyox, and mixtures thereof prevented the filtration using water through a coffee filter, although the results were dependent on the amount of the disposal device agent present in the formulation. Moreover, Carbopol 71G, Carbopol 971P, Carbopol 974P, xanthan gum and sodium alginate (Keltone) either completely prevented filtration or considerably decreased filtration rate when formulations comprised 20% or less of the disposal device agent (on a dry weight basis).

### Example 2

### Extraction and Filtration Testing of Coated Pellet Formulations

Pellets containing disposal device agents xanthan gum, Carbopol, and sodium alginate were prepared by extrusion/spheronization and enterically coated. Table 4 provides representative pellet formulations.

TABLE 4
Coated Pellet Formulations.

| | w/w on dry basis | | | | | | |
|---|---|---|---|---|---|---|---|
| Lot | Disposal | | | Poly- | | | |
| (L066) | Device Agent | MCC | Lactose | plasdone | NaHCO₃ | Talc | Granulation liquid |
| -01002 | CPL (20.0%) | 70.0% | — | 10.0% | — | — | Water: (44.0%) |
| -01003 | CPL (10.0%) | 80.0% | — | 10.0% | — | — | Water: (30.1%) |
| -01004 | CPL (13.5%) | 49.5% | 36.0% | — | — | — | Water/CaCl₂ (1%): (40.0%) |
| -01005 | CPL (20.0%) | 80.0% | — | — | — | — | EtOH anhydrous: (36.4%) |
| -01006 | XG (20.0%) | 80.0% | — | — | — | — | EtOH-Water (61:39): (73.3%) |
| -01007 | XG (16.0%) | 60.0% | 16.0% | — | — | — | EtOH-Water (50:50)/PVP |
| | | | | | | | K29/32 (8%): (50.0%) |
| -01008 | XG (18.0%) | 60.0% | 16.0% | — | — | — | EtOH-Water (45:55)/PVP |
| | | | | | | | K29/32 (6%): (85.0%) |
| -01009 | CPL (18.0%) | 60.0% | 10.0% | — | 9.0% | — | EtOH-Water (45:55)/PVP |
| | | | | | | | K29/32 (3%): (15.2%) |
| -01010 | CPL (15.0%) | 60.0% | 18.0% | — | 4.0% | — | EtOH-Water (92.7:7.3)/PVP |
| | | | | | | | K29/32 (3%): (15.2%) |
| -01011 | CPL (15.0%) | 60.0% | 18.0% | — | 5.0% | — | EtOH anhydrous/PVP K29/32 |
| | | | | | | | (2%): (38.2%) |
| -01012 | CPL (12.0%) | 60.0% | 18.0% | 4.0% | 2.0% | — | EtOH-Water (92.7:7.3)/PVP |
| | | | | | | | K29/32 (4%): (30.0%) |
| -01013 | CPL (11.0%) | 70.0% | — | — | 1.0% | 18.0% | EtOH-Water (92.7:7.3): |
| | | | | | | | (35.8%) |
| -01014 | SA (30.0%) | 60.0% | — | — | — | 10.0% | EtOH-Water (45:55): (109.6%) |
| -01015 | SA (30.0%) | 50.0% | 10.0% | — | — | 5.0% | EtOH-Water (45:55)/PVP |
| | | | | | | | K29/32 (5%) and CPL (0.6%): |
| | | | | | | | (100.0%) |
| -01016 | SA (50.0%) | 45.0% | — | — | — | — | EtOH-Water (32:68)/PVP |
| | | | | | | | K29/32 (5%): (100.0%) |
| -01017 | SA (40.0%) | 40.0% | 12.0% | — | — | — | EtOH-Water (40:60)/PVP |
| | | | | | | | K29/32 (8%): (81.0%) |
| -01018 | SA (40.0%) | 40.0% | 10.0% | — | — | — | EtOH-Water (35:65)/PVP |
| | | | | | | | K29/32 (10%): (70.0%) |

CPL = Carbopol 71G;
XG = Xanthan Gum;
SA = Sodium Alginate (Keltone).

The parameters of operation for lots L066-01008, L066-01013, L066-01015 and L066-01018 where an acceptable pelletization, accompanied by a significant increase of aqueous phase viscosity was obtained, are listed in Table 5.

TABLE 5
Extrusion/Spheronization Parameters for Lots
L066-01008, -01013, -01015, and -01018.

| | Formulation | | | |
|---|---|---|---|---|
| | -01008 | -01013 | | |
| | (Xanthan | (Carbopol | -01015 | -01018 |
| Parameters | Gum) | 971P ) | (Keltone) | (Keltone) |

Dry Blending

| | | | | |
|---|---|---|---|---|
| Batch size (g) | 200 | 100 | 100 | 100 |
| Pre-mix time (min) | 3 | 5 | 4 | 3 |
| Mixer speed (rpm) | 60 | 60 | 60 | 60 |

Wet Granulation

| | | | | |
|---|---|---|---|---|
| Dose time | 8:44 | 2:00 | 5:00 | 3:41 |
| (min:sec) | | | | |
| Total mix time | 10:00 | 2:00 | 5:30 | 4:41 |
| (min:sec) | | | | |
| Mixer speed (rpm) | 60 | 60 | 60 | 60 for 3:41 |
| | | | | 124 for 1:00 |
| Liquid rate (g/min) | 19.5 | 18.0 | 20.0 | 19.0 |
| Granulation | 85.0 | 35.8 | 100.0 | 70.0 |
| liquid (% w/w) | | | | |
| on dry basis | | | | |

Extrusion

| | | | | |
|---|---|---|---|---|
| Shaft speed (rpm) | 30 | 50 | 30 | 30 |
| Die diameter (mm) | 1.0 | 1.0 | 1.0 | 1.0 |
| | (Dome) | (Dome) | (Dome) | (Dome) |

Spheronization

| | | | | |
|---|---|---|---|---|
| Plate speed (rpm) | 1250/1000/ | 1000 | 750/500 | 500 |
| | 1750/1250 | | | |
| Spheronization | 1/6/4/2 | 8 | 1/2 | 10 |
| time (min) | | | | |

The use of xanthan gum, Carbopol, or sodium alginate for the preparation of pellets by extrusion/spheronization using pure water as granulating liquid posed a number of technological problems leading to a non-robust process. Intrinsic adhesion/stickiness of disposal device agents led to poor yields, although this problem was addressed by adding some additives to the granulating liquid. While some of these approaches reduced the viscosity, using an ethanol-water mix as the granulating liquid allowed an acceptable pelletization process without affecting the physical properties of the polymers used.

Formulations containing xanthan gum (18% in lot L066-01008), Carbopol 971P (11% in lot L066-01013) and sodium alginate (30% and 40% in lots L066-01015 and L066-01018, respectively) were then produced with adequate yields for stability purposes. The pellets having size≧0.5 mm were evaluated in terms of yield (Table 6) and shape. The yields were calculated in relation to the starting powdered material. A higher level of fine materials was observed in lots L066-01015 (sodium alginate, 30%) and L066-01022 (meglumine, 20%), which represent good ranges of yields.

TABLE 6
Process Yields of Promising Formulations Containing
Carbopol, Xanthan Gum, Sodium Alginate and Meglumine.

| Lot (L066) | Yield_{≧0.5 mm} (%) |
|---|---|
| -01008 | 85.2 |
| -01013 | 74.4 |
| -01015 | 64.8 |
| -01018 | 75.3 |
| -01022A* | 67.4 |
| -01023* | 85.3 |

*See Table 10 for formulation.

### Extraction Testing

Extraction testing was performed to determine how easily an active ingredient or targeted substance from the medicament can be extracted once it is absorbed or combined with the pellets. Caffeine was used as the active agent.

To prepare the pellets, caffeine (2 g) was dry blended with 8.0 g of MCC (MCC, Tabulose 101) using mortar and pestle. The disposal device agents-pellets were grinded for 15 seconds (uncoated pellets) or 30 seconds (coated pellets) using a hand coffee grinder (Black & Decker Home). Finally, 2.5 grams of Caffeine-MCC mix (20:80) and 2.5 grams of grinded pellets were mixed in a container with the aid of a spoon.

The extraction of the caffeine from 1 g of caffeine-disposal device agent-pellets was tested by dispersion and filtration using 10 ml of: (a) tap water, (b) vodka, (c) apple juice, (d) orange juice, and (e) 7 Up® soft drink. All these liquids were allowed to acclimate to room temperature for two hours before testing.

The caffeine-disposal device agent-pellets were transferred into a container and the extraction liquid was added. The mixtures were vigorously shaken until homogeneous. When it was necessary, the homogenization was completed with the aid of spatula. The resulting suspensions were immediately filtered thought a coffee filter (GK Connaisseur).

As controls, 0.5 grams of caffeine-MCC mix (20:80) were transferred into a container and the extraction liquid was added and the mixtures were vigorously shaken until homogeneous. The resulting suspension was immediately filtered thought a coffee filter (GK Connaisseur).

Model drug caffeine extraction using various easily available liquids from formulations containing xanthan gum, Carbopol, and sodium alginate are presented in Table 7.

TABLE 7
Extraction and Filtration of Caffeine Using Different Solvents for Control Lots
and Lots L066-01008, -01013, -01015, and -01018.⁽¹⁾

| | | | | Disposal | | |
|---|---|---|---|---|---|---|
| | | | | Device | | |
| | Disposal | Extraction | Caffeine | Agent | | |
| | Device-Pellet | Solvent | Conc.⁽²⁾ | Conc.⁽³⁾ | Filtration Rate | Caffeine Conc. |
| Sample | Sample | (Volume ml) | (mg) | (mg/ml) | (ml/min) | in filtrate |
| Control-1 | NA | Water (10) | 10.0 | 0 | 10/0:54 | 9.4 |
| Control-2 | NA | Water (20) | 5.0 | 0 | 10/2:22 | 5.4 |
| Control-3 | NA | Vodka (10) | 10.0 | 0 | 10/2:42 | 9.9 |
| Control-4 | NA | Apple Juice | 10.0 | 0 | 10/1:15 | 8.9 |
| | | (10) | | | | |
| Control-5 | NA | Orange Juice | 10.0 | 0 | 10/4:35 | 8.9 |
| | | (10) | | | | |
| Control-6 | NA | 7 Up (10) | 10.0 | 0 | 10/1:34 | 9.1 |
| -01008-1 | XG (18%) | Water (10) | 10.0 | 9.0 | 0 | NA |
| -01008-2 | XG (18%) | Water (20) | 5.0 | 4.5 | 0 | NA |
| -01008-3 | XG (18%) | Vodka (10) | 10.0 | 9.0 | 2.4/10:00 | 8.3 |
| -01008-4 | XG (18%) | Apple Juice | 10.0 | 9.0 | 3.4/10:00 | 8.6 |
| | | (10) | | | | |
| -01008-5 | XG (18%) | Orange Juice | 10.0 | 9.0 | 1.0/10:00 | 8.2 |
| | | (10) | | | | |
| -01008-6 | XG (18%) | 7 Up (10) | 10.0 | 9.0 | 0.2/10:00 | Not tested |
| -01013-1 | CPL (11%) | Water (10) | 10.0 | 5.5 | 0 | NA |
| -01013-2 | CPL (11%) | Water (20) | 5.0 | 2.8 | 0.4/10:00 | Not tested |
| -01013-3 | CPL (11%) | Vodka (10) | 10.0 | 5.5 | 0.3/10:00 | Not tested |
| -01013-4 | CPL (11%) | Apple Juice | 10.0 | 5.5 | 5.7/10:00 | 7.5 |
| | | (10) | | | | |
| -01013-5 | CPL (11%) | Orange Juice | 10.0 | 5.5 | 5.8/10:00 | 9.1 |
| | | (10) | | | | |
| -01013-6 | CPL (11%) | 7 Up (10) | 10.0 | 5.5 | 3.6/10:00 | 9.8 |
| -01015/ | SA (36%) | Water (10) | 10.0 | 18.0 | 1.7/10:00 | 0.0 |
| -01018-1 | | | | | | |
| -01015/ | SA (36%) | Water (20) | 5.0 | 18.0 | — | NA |
| -01018-2 | | | | | | |
| -01015/ | SA (36%) | Vodka (10) | 10.0 | 18.0 | 5.3/10:00 | 9.7 |
| -01018-3 | | | | | | |
| -01015/ | SA (36%) | Apple Juice | 10.0 | 18.0 | 0 | NA |
| -0118-4 | | (10) | | | | |
| -01015/ | SA (36%) | Orange Juice | 10.0 | 18.0 | 0 | NA |
| -0118-5 | | (10) | | | | |
| -01015/ | SA (36%) | 7 Up (10) | 10.0 | 18.0 | 1.1/10:00 | 7.3 |
| -01018-6 | | | | | | |

⁽¹⁾5 grams of formulation were prepared: 2.5 grams of Caffeine (20%)-MCC-101 (80%) formulation + 2.5 grams of grinded enteric-coated pellets.
⁽²⁾Assumes that all the caffeine has dissolved.
⁽³⁾For example, XG: (1000 mg/g × 0.5 g of grinded pellets) × 0.18/10 ml solvent = 9.0 mg/ml.
(4) Determined by HPLC analysis.
(5) Lot L066-01015 and -01018 were mixed: 40.4 g of lot L066-01015 (30%) + 49.3 g of lot L066-01018 (40%) = 36% of SA.
Not tested: only the samples where 1 ml or more was recovered after 10 minutes were tested by HPLC caffeine assay;
NA: not applicable, no fluid passed through the coffee filter; Apple juice pH = 3.5, Orange juice pH = 3.8, 7 Up pH = 3.3.

All tested disposal device agent pellets-formulations reduced the overall amount of drug extractable with the solvent when compared with a non-disposal device agent formulation (controls C-1 to C-6). When 0.5 grams of xanthan gum (lot L066-01008) or Carbopol (lot L066-01013) (grinded pellets) were mixed with 0.5 grams of caffeine-MCC mix and water (10 or 20 ml), a viscous or semi-viscous aqueous liquid completely or practically unfilterable was obtained. In particular, the Carbopol 971P-based pellets considerably decreased the filtration rate from 10 ml in less than 3 minutes to 0.3 ml in 10 minutes. Xanthan gum pellets reduced the amount of filtrate using acidic juice as solvent, although it did not prevent caffeine extraction, except when 7 Up was used.

Carbopol swelling is pH dependant. In acidic media (apple juice pH=3.5, orange juice pH=3.8 and 7 Up pH=3.3), the filtration rate was only slightly decreased and all the caffeine containing formulations could be extracted. Sodium alginate (Keltone)-based pellets prevented the filtration with acidic juices, but not with vodka or 7 Up. However, using water as the solvent, a small amount of aqueous solution (1.7 ml) passed though the coffee filter, although no caffeine was found by analytical testing. That could be due to drug entrapping within the sodium alginate matrix. The resultant filtrate for this sample was a cloudy liquid with suspended particles. Prior to USP-based HPLC assay, the solutions were filtrated using 5 ml BD™ syringe with a filter nylon membrane (pore size 0.45 μm).

### Example 3

### Extraction and Filtration Testing of Uncoated Pellet Formulations

Pellets containing disposal device agent Carbopol and alkalining agent meglumine were prepared by extrusion/spheronization to test how they may be used to dispose immediate release (IR) morphine sulfate/oxycodone HCl tablets.

IR direct compression tablets were prepared with morphine sulfate and oxycodone HCl in quantities of either 3 mg and 2 mg, respectively (lot L066-044A), or 12 mg and 8 mg, respectively (lot L066-044B). The formulations are shown in Table 8.

TABLE 8
Tablet Formulations.

| | | | mg/unit | |
|---|---|---|---|---|
| | | % by | Lot 044A- | Lot 044B- |
| Item | Ingredient name | weight | 5 mg | 20 mg |
| a | Morphine sulfate | 3.0 | 3.0 | 12.0 |
| b | Oxycodone HCl | 2.0 | 2.0 | 8.0 |
| c | Carbopol 971P powder | 1.5 | 1.5 | 6.0 |
| d | Meglumine powder | 0.6 | 0.6 | 2.4 |
| e | Pregelatinized corn starch | 58.0 | 58.0 | 232.0 |
| f | Microcrystalline cellulose | 30.9 | 30.9 | 123.6 |
| | MCC-102 | | | |
| g | Microcrystalline cellulose | 2.0 | 2.0 | 8.0 |
| | MCC-102 | | | |
| h | Colloidal silicon dioxide | 1.0 | 1.0 | 4.0 |
| i | Magnesium stearate | 1.0 | 1.0 | 4.0 |

| | | | |
|---|---|---|---|
| Total: | 100.0 | 100.0 | 400.0 |

The tablets were prepared by dry blending direct compression technique. Magnesium stearate, colloidal silicon dioxide and a part of microcrystalline cellulose (item g) were mixed and then sieved using a 30 mesh sieve. The other powders were sieved using a 30 mesh sieve before mixing using a blender. The tablets were then compressed.

### Extraction Testing

Tablet formulations were submitted to extraction attempts with water and alcoholic beverage. The extraction was carried out under different extraction conditions such as crushing, agitation (by shaking or using a spoon), heating or cooling and using different extraction solvent volumes.

The mixtures were immediately filtered through a standard coffee filter. Filtration rate was evaluated by comparing amount of filtered liquid phase recovery after at least 10 minutes compared to the initial volume used for extraction attempt.

Four extraction methods were used:
Method 1: Tablets were immersed into the room temperature solvent and the mixture was homogenized by hand mixing.
Method 2: Tablets were immersed into the solvent and the mixture was heated to boiling using a microwave (about 30 sec). The remaining pieces of tablets were crushed using a spoon.
Method 3: Tablets were immersed into the solvent and the mixture was heated in a glass beaker (closed with aluminum foil) using a hot plate for about 2 minutes. The remaining pieces of tablets were crushed using a spoon.
Method 4: Tablets were immersed into the solvent recently removed from the refrigerator (5-10° C.) and the mixture was homogenized by hand mixing while crushing the tablets.

The results of the extraction tests are shown in Table 9.

TABLE 9
Extraction and Filtration Results for Lots L066-044A and -044B.

| | Solid | | | | | |
|---|---|---|---|---|---|---|
| Sample | phase | | | API | Filtrate | Recovery |
| (L066) | (g) | Sample # | Extraction Method | (mg/ml) | (g)* | (%) |
| -01044B- | 1.0⁽¹⁾ | 1 | Method 1: water 10 ml at RT | 5 | 0 | 0 |
| T = 0 | | 2 | Method 1: water 20 ml (10 ml | 2.5 | 4.6 | 23 |
| | | | of water at RT was added to | | | |
| | | | sample#1) | | | |
| | 1.0⁽¹⁾ | 3 | Method 1: vodka 10 ml at RT | 5 | 2.2 | 22 |
| -01044B | 1.2⁽²⁾ | 4 | Method 2: boiling water 10 ml. | 6 | 0 | 0 |
| 3 months | | 5 | Method 2: boiling water 20 ml | 3 | 0 | 0 |
| | | | (10 ml of water at RT added to | | | |
| | | | sample # 4) | | | |
| | | 6 | Method 2: boiling water 30 ml | 2 | 2.7 | 9 |
| | | | (10 ml of water at RT added to | | | |
| | | | sample # 5) | | | |
| | 1.2⁽²⁾ | 7 | Method 2: boiling Vodka 10 ml | 6 | Evaporation | NA |
| | 1.2⁽²⁾ | 8 | Method 3: boiling Vodka 15 ml | 4 | 4.4 | 29 |
| -01044A | 1.0⁽¹⁾ | 18 | Method 4: water 10 ml 5° C. | 5 | 1.4 | 14 |
| 3 months | 1.0⁽¹⁾ | 19 | Method 1: water 10 ml at RT | 5 | 2.5 | 25 |
| 25° C./60% RH | 1.0⁽¹⁾ | 20 | Method 1: vodka 10 ml at RT | 5 | 3.1 | 31 |
| -01044B | 1.2⁽²⁾ | 21 | Method 4: water 10 ml 5° C. | 6 | 1.0 | 10 |
| 3 months | 1.2⁽²⁾ | 22 | Method 1: water 10 ml at RT | 6 | 1.1 | 11 |
| 25° C./60% RH | 1.2⁽²⁾ | 23 | Method 2: boiling water 10 ml | 6 | 0.8 | 8 |
| | 1.2⁽²⁾ | 24 | Method 4: vodka 10 ml 10° C. | 6 | 4.1 | 41 |
| | 1.2⁽²⁾ | 25 | Method 1: vodka 10 ml at RT | 6 | 3.4 | 34 |
| | 1.2⁽²⁾ | 26 | Method 3: boiling vodka 10 ml | 6 | 1.8 | 18 |

⁽¹⁾Crushed tablets
⁽²⁾Whole tablets

Recovery of the morphine sulphate/oxycodone HCl ranged between 0 and 42% with water or vodka by mixing with the solvent.

### Example 4

### Evaluation of Granulation Liquids

The liquid vehicles shown in Table 10, which are known to be used in oral liquid formulations as solubilizers, vehicles, or absorption enhances, were tested as potential granulating liquids for the extrusion/spheronization process.

The liquid was added until an appropriate powder cohesiveness was achieved to obtain a rounded shape mass under pressure. Filtration testing was carried out immediately after preparation of the mixture.

TABLE 10
Granulating Liquids evaluated for MCC-Carbopol Formulations.

% w/w on dry basis

| | | | Carbopol |
|---|---|---|---|
| Sample | Liquid vehicle* | MCC-101 | 971P |
| L-1 | Labrasol: 50.0 | 50.0 | 0 |
| L-2 | Labrasol: 28.7 | 55.9 | 15.4 |
| L-3 | Labrafil M 1944 CS: 33.3 | 50.0 | 16.7 |
| L-4 | Labrafil M 1944 CS/Water | 50.0 | 16.7 |
| | (80:20): 33.3 | | |
| L-5 | Transcutol P: 22.1 | 58.6 | 19.2 |
| L-6 | PEG-400: 33.6 | 53.1 | 13.3 |
| L-7 | Captex 200: 38.4 | 40.7 | 20.9 |
| L-8 | Capmul MCM: 34.5 | 49.0 | 16.5 |
| L-9 | Cremophor EL: 30.7 | 51.4 | 17.8 |

*Labrasol = caprylocaproyl macrogol-8 glycerides; Labrafil = oleoyl macrogol-6 glycerides; Transcutol = 2-(2-ethoxyethoxy)ethanol; PEG = polyethylene glycol; Captex = propylene glycol dicaprylocaprate; Capmul MCM = medium chain mono- and diglycerides; Cremophor EL = polyethoxylated castor oil.

New solvents as potential granulating liquids were evaluated in order to avoid sticking issues with water, and solvent recovery of ethanol (Table 11). The results show that Transcutol, PEG-400 and Cremophor could be employed as a liquid binder having adequate cohesiveness without affecting the properties of Carbopol as disposal device agent in water and vodka as extraction solvents.

TABLE 11
Liquid Vehicles as Granulating Fluid for MCC-101: Carbopol 971P Formulations.

| | % w/w on dry basis | | | Results | |
|---|---|---|---|---|---|
| Sample | Liquid vehicle* | MCC | Carbopol | Cohesiveness | Filtration** |
| L-1 | Labrasol: 50.0 | 50.0 | 0 | No | Water: Filterable |
| L-2 | Labrasol: 28.7 | 55.9 | 15.4 | Yes | Water: Filterable |
| L-3 | Labrafil: 33.3 | 50.0 | 16.7 | Slight | Water: Unfilterable |
| | | | | | Vodka: Filterable |
| L-4 | Labrafil/Water (80:20): | 50.0 | 16.7 | Yes | Water: Unfilterable |
| | 33.3 | | | | Vodka: Filterable |
| L-5 | Transcutol P: 22.1 | 58.6 | 19.2 | Yes | Water: Unfilterable |
| | | | | | Vodka: Unfilterable |
| L-6 | PEG-400: 33.6 | 53.1 | 13.3 | Yes | Water: Unfilterable |
| | | | | | Vodka: Unfilterable |
| L-7 | Captex 200: 38.4 | 40.7 | 20.9 | Slight | Water: Unfilterable |
| | | | | | Vodka: Unfilterable |
| L-8 | Capmul MCM: 34.5 | 49.0 | 16.5 | Slight | Water: Unfilterable |
| | | | | | Vodka: Unfilterable |
| L-9 | Cremophor EL: 30.7 | 51.4 | 17.8 | Yes | Water: Unfilterable |
| | | | | | Vodka: Unfilterable |

*Labrasol = caprylocaproyl macrogol-8 glycerides; Labrafil = oleoyl macrogol-6 glycerides; Transcutol = 2-(2-ethoxyethoxy)ethanol; PEG = polyethylene glycol; Captex = propylene glycol dicaprylocaprate; Capmul MCM = medium chain mono- and diglycerides; Cremophor EL = polyethoxylated castor oil.
**0.5 grams of mix in 10 ml of solvent; Unfilterable: volume filtrate less than 1 ml after 10 minutes.

The different granulating liquids were further evaluated in pellet formulations prepared with Carbopol (lot L066-01019) and Carbopol/sodium alginate (lot L066-01020). For pelletization, 100 g/batch were prepared. The powdered materials were first blended for about 1 minute and the mixture was sieved using a 20 mesh sieve. The liquid was slowly added into the mixture until all the material was granulated. The wet mass extruded was immediately using LCI Multi Granulator MG-55, dome configuration with a 1.2 mm die and extrusion speed ranging from 30-50 rpm. The extrudates were spheronized at speeds between 500 and 1750 rpm for up to 20 minutes on a LCI Marumerizer QJ-230T equipped with 2.0 mm friction plate. Description of the formulations composition evaluated can be found in Table 12.

TABLE 12
Carbopol and Carbopol/Sodium Alginate Extrusion/Spheronization Formulations.

| | % w/w on dry basis | | | | | |
|---|---|---|---|---|---|---|
| | | MCC- | | | | |
| Lot (L066) | IVA | 101 | Lactose | Talc | Compritol | Granulation liquid |
| -01019A | CPL: 19.0 | 59.0 | — | — | — | Transcutol: 22.0 |
| -01019B | CPL: 15.0 | 47.0 | — | — | — | Captex: 34/ |
| | | | | | | Transcutol: 4.0 |
| -01019C | CPL: 20.0 | 80.0 | — | — | — | Isopropanol 70%: |
| | | | | | | 44.5 |
| -01019D | CPL: 14.0 | 54.0 | — | — | — | PEG: 33.0/EtOH- |
| | | | | | | 95%: 4.4 |
| -01019E | CPL: 20.0 | 80.0 | — | — | — | Isopropanol 99.5%: |
| | | | | | | 36.4 |
| -01019F | CPL: 15.0 | 79.0 | — | 6.0 | — | Isopropanol 99.5%: |
| | | | | | | 35.1 |
| -01019G | CPL: 12.5 | 82.5 | — | 5.0 | — | Isopropanol 99.5%: |
| | | | | | | 19.5 |
| -01019H | CPL: 15.0 | 60.0 | 25.0 | — | — | Isopropanol 99.5%: |
| | | | | | | 26.0 |
| -01019I | CPL: 12.0 | 58.0 | 30.0 | — | — | EtOH-95%: 17.3 |
| -01019J | CPL: 15.0 | 50.0 | 10.0 | 15.0 | — | Water: 5.0/EtOH- |
| | | | | | | 95%: 20.0/CO: 10.0 |
| -01019K | CPL: 12.5 | 67.5 | — | 15.0 | — | EtOH-95%: |
| | | | | | | 20.0/CO: 5.0 |
| -01020A | SA: 30.0/CPL: 5.0 | 65.0 | — | — | — | Water: 12.9/EtOH- |
| | | | | | | 95%: 19.0 |
| -01020B | SA: 25.0/CPL: 5.0 | 70.0 | — | — | — | Water: 16.0/EtOH- |
| | | | | | | 95%: 24.0 |
| -01020C | SA: 10.0/CPL: 10.0 | 70.0 | — | 2.0 | — | EtOH-95%: 16.0/ |
| | | | | | | Transcutol: 9.0 |
| -01020D | SA: 10.0/CPL: 10.0 | 55.0 | 25.0 | — | — | Water: 2.4/EtOH- |
| | | | | | | 95%: 20.3 |
| -01020E | SA: 10.0/CPL: 10.0 | 50.0 | 12.5 | 12.5 | — | EtOH-95%: CO |
| -01020Eb | SA: 35.0/CPL: 5.0 | 45.0 | 5.0 | 4.0 | — | Water: 16.7/EtOH- |
| | | | | | | 95%: 40.5/CO: 6.0 |
| -01020F | SA: 35.0/CPL: 7.0 | 48.0 | — | 3.0 | — | Water: 18.8/EtOH- |
| | | | | | | 95%: 39.0/CO: 7.2 |
| -01020G | SA: 35.0/CPL: 5.0 | 50.4 | — | 3.6 | — | Water: 13.0/EtOH- |
| | | | | | | 95%: 30.0/CO: 6.6 |
| -01020H | SA: 30.0/CPL: 5.0 | 45.0 | 10.0 | 5.0 | — | Water: 12.5/EtOH- |
| | | | | | | 95%: 12.5/CO: 5.0 |
| -01020I | SA: 30.0/CPL: 1.50/ | 42.0 | 10.0 | 4.5 | — | Water: 21.0/EtOH- |
| | CPL974: 6.5 | | | | | 95%: 9.0/CO: 5.4 |
| -01020J | SA: 30.0/CPL: 5.0 | 44.6 | 10.6 | — | 5.0 | Water: 15.6/EtOH- |
| | | | | | | 95%: 10.4/CO: 5.0 |

SA: Sodium alginate (Keltone);
CPL: Carbopol 971;
CO: Castor oil

For the filtration testing, the pellets were powdered using mortar and pestle. Filtration testing was done using a standard coffee filter (LIFE, Pharmaprix). 10 ml of water and vodka, were mixed with 0.5 g of powdered pellets and immediately filtrated. The recovered liquid (filtrate) was weighed after 10 minutes.

### Example 5

### Evaluation of Carbopol 971P and Alkalining Agent Formulations

Formulations were prepared for determining the effects of alkalining agents, since medicaments in the form of liquids for injection are often acidic. To prepare Carbopol formulations without alkalining agents at 100 to 200 g/batch, the powdered materials were first blended for about 1 minute and the mixture was sieved using a 20 mesh sieve. Powders premixing was completed in a Hobart Model N-50 planetary mixer for about 2 minutes at low speed (60 rpm) and about 45 seconds at 124 rpm. The granulating liquid (water or CaCl₂ aqueous solution) was slowly added into the mixture until all the material was granulated. The wet mass was then extruded immediately by dome extrusion using a LCI Multi Granulator MG-55 fitted with a 1.0 or 1.2 mm die and extrusion speed of 30 or 50 rpm. The extrudates were spheronized at speeds between 960 and 1800 rpm for up to 20 minutes using a LCI Marumerizer QJ-230T equipped with 2.0 mm friction plate. Pellets were enterically coated using the same procedure described previously.

To prepare formulations that included meglumine or sodium bicarbonate as an alkalining agent, the same procedure described above for the Carbopol pelletization was used, except that 1.0 mm die and extrusion speed at 50 rpm was used. Also, spheronization speeds between 250 and 500 rpm for up to 10 minutes were used.

The formulation compositions evaluated are shown in Table 13. The parameters of operation for the most promising formulations can be found in Table 14.

TABLE 13
Carbopol and Alkalining agents Extrusion/Spheronization Formulations.

| Lot | % w/w on dry basis | | | | |
|---|---|---|---|---|---|
| (L066) | Carbopol 971P | MCC-101 | Lactose | Other | Granulation liquid |
| -01004A | 13.5 | 49.5 | 36.0 | — | Water: 40/CaCl₂: 1.0 |
| -01004B | 20.0 | 50.0 | 29.0 | — | Water: 36/CaCl₂: 1.0 |
| -01004C | 15.0 | 55.0 | 29.0 | — | Water: 31/CaCl₂: 1.0 |
| -01004D | 15.0 | 36.0 | 36.0 | Polyplasdone XL-10: 8.0 | Water: 36/CaCl₂: 1.8 |
| | | | | Talc: 3.2 | |
| -01004E | 13.5 | 49.5 | 36.0 | — | Water: 40/CaCl₂: 1.0 |
| -01004F | 13.5 | 49.0 | 25.5 | Polyplasdone XL-10: 8.0 | Water: 34/CaCl₂: 1.0 |
| | | | | Talc: 3.0 | |
| -01004G | 13.0 | 50.0 | 30.0 | Talc: 6.0 | Water: 40/CaCl₂: 1.0 |
| -01022A | — | 80.0 | — | Meglumine: 20.0 | Water: 55.5 |
| -01022B | — | 79.6 | — | Meglumine: 20.0 | Water: 40/Opadry: 0.8 |
| -01023 | 10.0 | 90.0 | — | — | Water: 45.0 |
| -01024 | — | 15.0 | — | NaHCO₃: 80.0 | Water: 23.8 |
| | | | | PVP 29/30: 5.0 | |

TABLE 14
Extrusion/Spheronization Parameters for Lot L066-01004
(Carbopol/CaCl₂), -01022 (Meglumine), and -01023 (Carbopol).

| | Formulation | | | | |
|---|---|---|---|---|---|
| | | | | -01022A and | |
| Parameters | -01004A | -01004E | -01004G | -01022B | -01023 |

Dry Blending

| | | | | | |
|---|---|---|---|---|---|
| Batch size (g) | 100 | 100 | 100 | 100 | 200 |
| Pre-mix time (min) | 2 | 2 | 2 | 2 | 2 |
| Mixer speed (rpm) | 60 | 60 | 60 | 60 | 60 |

Wet Granulation

| | | | | | |
|---|---|---|---|---|---|
| Dose time (min:sec) | 0:53 | 0:57 | 1:18 | 1:17 | 4:18 |
| Total mix time | 1:38 | 2:02 | 2:18 | 2:17 | 6:10 |
| (min:sec) | | | | | |
| Mixer speed (rpm) | 60/124 (45 sec) | 60/124 (45 sec) | 60/124 (43 sec) | 60 | 60 |
| Liquid rate (g/min) | 45.3 | 43.0 | 30.9 | 43.2 | 20.9 |
| Granulation liquid | 40.0 | 40.0 | 40.0 | 55.5 | 45.0 |
| (% w/w) on dry basis | | | | | |

Extrusion (Dome)

| | | | | | |
|---|---|---|---|---|---|
| Shaft speed (rpm) | 50 | 50 | 30 | 50 | 30 |
| Die diameter (mm) | 1.0 | 1.0 | 1.0 | 1.0 | 1.0 |

Spheronization

| | | | | | |
|---|---|---|---|---|---|
| Plate speed (rpm) | 1800/1000 | 1800/1500 | 1800 | 500/250 | 960-1750 |
| Spheronization time | 9/9 | 8/10 | 20 | 3/3 | 17 |
| (min) | | | | | |

For the filtration/extraction testing, two extraction methods were used: dry grinding, and wet grinding. In the dry grinding method, Carbopol and meglumine pellets were grinded separately for 1 minute using mortar pestle. 10 ml of solvent was added to different ratios of Carbopol/meglumine grinded pellets and the mixture was vigorously shaken for less than one minute and immediately filtrated through a coffee filter. After 10 minutes, the filtrate was weighed.

In the wet grinding method, different ratios of Carbopol/meglumine pellets were introduced in a mortar. The pellets were too hard to be easily crushed by hand. The solvent was then introduced into the mortar and the material was wet-milled in solvents. The mix was filtered through a coffee filter. After 10 minutes, the filtrate was weighed.

Carbopol 971P (13.5%) pellets could be produced using a CaCl₂ aqueous solution as granulating liquid. CaCl₂ reduced in-process viscosity of the Carbopol and allowed proper yield. However, CaCl₂ also reduced the swelling properties of Carbopol during extraction testing. This could be prevented by adding an alkalining agent such as meglumine within the formulation. In formulation lot L066-01023, Carbopol 971P percentage was decreased from 13.5% to 10% and pellets were produced with pure water as granulating liquid avoiding the use of CaCl₂ (see Table 13). Meglumine-based pellets were produced (lot L066-01022) separately in order to avoid in process swelling of Carbopol. Table 15 shows that the use of a 60:40 ratio of Carbopol and meglumine pellets from lots L066-01004 and L066-01022, as well as a 70:30 ratio of Carbopol and meglumine pellets from lots L066-01023 and L066-01024, led to viscous aqueous solutions and reduced filtration rate.

Extraction results depended mainly on the extraction approach. Using a coffee grinder for 1 min, mixing with solvent by shaking for a few seconds and immediate filtrating through a coffee filter, the mixtures could be filtered as pellets integrity was maintained. In these tests it was found that the filtrates consisted of cloudy liquid containing all caffeine. Although, by pulverisation using mortar and pestle, filtration was not possible using water and vodka. Sodium bicarbonate was also evaluated as an alkalining agent. Pellets containing 80% of sodium bicarbonate (L066-01024) did not show the same behavior as compared to meglumine (17-20%) pellets in enhancing the swelling of Carbopol.

TABLE 15
Carbopol and Meglumine Formulations Filtration/Extraction Results.

| | | | | | | Caffeine in |
|---|---|---|---|---|---|---|
| Lot | CPL/AA | | | Method of | Filtrate wt | the filtrate |
| L066 | Pellets (%) | Solid phase (g) | Solvent | tampering | after 10 min | (mg/ml) |
| -01004A | CPL_{UP}: 13.5 | 004A: 0.5 (T = 0) | Water: 10 ml | (a) Grinding^{CG}; | Water: | NA |
| | | | | (b) Dissolving; and | Filterable | |
| | | | | (c) Filtration with | | |
| | | | | coffee filter | | |
| | | 004A: 0.5 | Water: 10 ml | (a) Crushing^{MP} | Water: 1.6 g | NA |
| | | (2 months) | | with solvent; and | | |
| | | | | (b) Filtration with | | |
| | | | | coffee filter | | |
| | | 004A: 0.5 | Water: 10 ml | (a) Crushing^{MP} with | Water: 0.0 g | NA |
| | | (2 months) + | Vodka: | solvent; and | Vodka: 0.0 g | |
| | | AA: 0.05 | 10 ml | (b) Filtration with | | |
| | | | | coffee filter | | |
| | | 004A: 0.5 | Water: 10 ml | (a) Crushing^{MP} | Water: 1.2 g | NA |
| | | (2 months) + | | with solvent; and | | |
| | | AA: 0.05) | | (b) Filtration with | | |
| | | | | gauze bandage | | |
| -01004GOA- | CPL_{CP}: 11.1* | 004GOA: 0.3 | Water: 10 ml | (a) Grinding^{CG}; | Water: 1.4 g | NA |
| -01022AOA | Meg_{CP}: 17.4** | 022AOA: 0.2 | | (b) Dissolving; and | | |
| | | (T = 0) | | (c) Filtration with | | |
| | | | | coffee filter | | |
| | | 004GOA: 0.6 | Water: 10 ml | (a) Grinding^{CG}; | Water: 1.4 g | NA |
| | | 022AOA: 0.4 | | (b) Dissolving; and | | |
| | | (T = 0) | | (c) Filtration with | | |
| | | | | coffee filter | | |
| | | 004GOA: 0.3 | Water: 10 ml | (a) Crushing^{MP} | Water: 0.2 g | NA |
| | | 022AOA: 0.2 | Vodka: | with solvent; and | Vodka: 0.3 g | |
| | | (T = 0) | 10 ml | (b) Filtration with | | |
| | | | | coffee filter | | |
| | | 004GOA: 0.6 | Water: 10 ml | (a) Crushing^{MP} | Water: 0.0 g | NA |
| | | 022AOA: 0.4 | Vodka: | with solvent; and | Vodka: 0.0 g | |
| | | (T = 0) | 10 ml | (b) Filtration with | | |
| | | | | coffee filter | | |
| -01004GOA- | CPL_{CP}: 11.1 | 004GOA: 0.3 | Water: 10 ml | (a) Grinding^{CG}; | Water: 4.1 g | Water: 8.4 |
| -01022AOA | Meg_{CP}: 17.4 | 022AOA: 0.2 | Vodka: | (b) Dissolving; and | Vodka: 4.0 g | Vodka: 9.7 |
| | | MCC-Caf: 0.5 | 10 ml | (c) Filtration with | | |
| | | (T = 0) | | coffee filter | | |
| | | 004GOA: 0.6 | Water: 10 ml | (a) Grinding^{CG}; | Water: 2.1 g | Water: 9.5 |
| | | 022AOA: 0.4 | | (b) Dissolving; and | | |
| | | MCC-Caf: 0.5 | | (c) Filtration with | | |
| | | (T = 0) | | coffee filter | | |
| | | 004GOA: 0.3 | Water: 10 ml | (a) Crushing^{MP} | Water: 0.3 g | NA |
| | | 022AOA: 0.2 | | with solvent; and | | |
| | | MCC-Caf: 0.5 | | (b) Filtration with | | |
| | | (T = 0) | | coffee filter | | |
| -01004E | CPL_{UP}: 13.5 | 004E: 0.5 | Water: 10 ml | (a) Grinding^{CG}; | Water: 1.6 g | NA |
| | | AAr: 0.05 (T = 0) | | (b) Dissolving; and | | |
| | | | | (c) Filtration with | | |
| | | | | coffee filter | | |
| -01023- | CPL_{UP}: 10.0 | 023: 0.7 | Water: 10 ml | (a) Crushing^{MP} | Water: 0.0 g | NA |
| -01022B | Meg_{UP}: 20.0 | 022B: 0.3 | | with solvent; and | | |
| | | | | (b) Filtration with | | |
| | | | | coffee filter | | |
| -01023- | CPL_{UP}: 10.0 | 023: 0.7 | Water: 10 ml | (a) Crushing^{MP} | Water: 2.5 g | NA |
| -01024 | NaHCO_{3 UP}: | 024: 0.3 | | with solvent; and | | |
| | 80.0 | | | (b) Filtration with | | |
| | | | | coffee filter | | |

Carbopol pellets (lot L0066-01004GOA) and meglumine pellets (lot L0066-01022AOA) were used.
UP: uncoated pellets;
CP: coated pellets;
AA: raw meglumine as alkalining agent;
CG: Coffee grinder;
MP: Mortar/pestle,
Filterable: all liquid pass through the filter;
NA: not applicable, filtrate ≦1.0 g or no caffeine in the mix.
*11.1% = 13.0% pellets/(100 + 4% (Opadry coating) + 13% (Acryl-Eze coating));
**17.4% = 20.0% pellets/(100 + 3% (Opadry coating) + 12% (Acryl-Eze coating))

### Example 6

### Carbopol/Meglumine Pellets Formulation

Carbopol pellets from formulation lot L066-01023 (MCC-101 (90%)/Carbopol 971P (10%) and water as granulating liquid) were mixed with meglumine pellets from formulation lot L066-01023 (MCC-101 (80%)/meglumine (20%)). About 200 g of this pellet mixture was coated with opadry (5%)/acryl-eze (20%) system for a coat weight gain (WG) of about 3 and 5%, respectively (Table 15).

The test performed with 1.0 g of uncoated pellets from lots L066-01023 and L066-01022 (ratio 2.3) showed that the drug cannot be extracted with 10 ml of water (Table 15).

TABLE 16
Carbopol pellets (70%) Meglumine pellets (30%)
coated with Opadry (sub-coating/Acryl-eze (enteric
coating) system (L066-01022-023OA)

| Lot # | | | Pellets %/ | |
|---|---|---|---|---|
| (L066) | Ingredients | g/batch | batch | %w/w after coating |
| -01023 | MCC-101: 90% | 144 | 70 | MCC-101: 80.2 |
| | Carbopol 971: 10% | | | Carbopol 971: 6.4 |
| -01022 | MCC-101: 80% | 62 | 30 | Meglumine: 5.6 |
| | Meglumine: 20% | | | Opadry: 2.6 |
| | | | | Acryl-eze: 5.1 |

| | | | |
|---|---|---|---|
| Total | 206.0 | 100.0 | 100.0 |

### Example 7

### Example of an Alginate Disposal Device Agent

An example of an alginate disposal device agent is provided in Table 17.

TABLE 17
Alginate Disposal Device:

| | Commercial Alginate impression material |
|---|---|
| Alginate | (http://www.juniordentist.com/alginate-impression- |
| preparation | material.html) |
| Composition | Ester salts of alginic acid(sodium or potassium or |
| | triethanolamine alginate) - 15% |
| | Calcium sulphate (reactor) - 16% |
| | Zinc oxide - 4% |
| | Potassium titanium fluoride - 3% |
| | Diatomaceous earth - 60% |
| | Sodium phosphate - 2% |
| Setting | 2 Na3PO4 + 3 CaSO4 á Ca3(PO4)2 + 3Na2SO4 |
| reaction | |
| Setting time | Type I (fast set): 1-2 min |
| | Type II (normal): 2-4.5 min. |
| Control of | Under control by manufacturers: |
| gelation time | By the amount of retarder added during manufacturer |
| | Under Control of user: |
| | By altering the W:P ratio |
| | By changing the mixing time. |
| | By altering the temp of water |
| | Increase in temp. decreases gelation time & vice versa |

### Example 8

### Preparation of the Disposal Device Material for Use in the Disposal Device

The following variations on making the disposal device material for the sachet are given by way of example:

The examples in Table 18 are scaled to provide a gelling effect in a 50 ml prescription product container bottle when the contents of a single sachet are added to or contained within the container along with the unused prescription product and water as the solvent. The examples in Table 18 represent dry blended materials that are filled into appropriately sized sachets. Specifically, the dry ingredients are pre-mixed in a Hobart low shear mixer/granulator (model N-50) at 60 rpm for 2 minutes.

In certain embodiments, the disposal device agents along with diluents and disintegrants listed in (A) may be wet granulated with an appropriate amount of water, dried and sized using a mechanical mill to increase the formulation density. In these embodiments, the glidant, lubricant and effervescent materials may be added to the dried and sized granules and filled into sachets. Particularly, the premixed disposal device agents, diluent, and disintegrant materials may be wetted using a Cole-Parmer peristaltic pump while mixing in a Hobart low shear mixer/granulator to form a homogeneous wet mass. The resulting wet mass is dried in an Aeromatic Strea-1 fluid bed dryer. The resulting dried granules are sized using a Quadro Comil U3 equipped with a grater screen with 810 micron openings. The dried and sized granules are blended together with glidant, lubricant, and/or effervescence in an 8-qt Patterson Kelley V-blender at 20 rpm for 2 minutes.

In some embodiments, the wet granulation from (B) is extruded and spheronized to further densify the formulations. Specifically, the wet material is placed into a LCI Multi Granulator MG-55 extruder through the die (screen) in order to obtain cylindrical extrudates. The extruder is fitted with a 1.0 mm die. The extrudates are placed into a LCI Marumerizer (spheronizer) QJ-230T equipped with 2.0 mm friction plate. Spheronizer friction plate speed and time are varied according to the formulations. The resulting pellets are dried on trays overnight at a temperature of 50° C. (Fisher Scientific Isotemp Oven Model 655F). The dried pellets are blended together with glidant, lubricant, and/or effervescence in an 8-qt Patterson Kelley V-blender at 20 rpm for 2 minutes.

In further embodiments, the granules in (B) or pellets from (C) are coated to provide a brief delay in the gelling effect in order to allow the effervescent material to agitate the mixture. Specifically, the dried and sized granules are coated with an immediate release coating such as Opadry Clear at 5% weight gain in an Aeromatic Strea-1 fluid bed equipped with a Wurster column. Granules may also be coated with an enteric coating such as Acryl-Eze at 10-20%. Acryl-Eze 20% w/w suspension is obtained by dispersing Acryl-Eze powder in distilled water according to the batch size. The suspension is stirred at room temperature for 40 min. The dispersion is screened through a 250 μm sieve prior to spraying process. The granules are coated to a weight gain of 10-20% w/w. The pump rate is between 2 and 3 g/min, and the inlet temperature is between 38-40° C. The atomizing air pressure is between 1.0-1.4 bars. The air flow rate is controlled in order to maintain a good fluidization and outlet temperature of not more than 32° C. After spraying, air temperature is maintained for an additional 3 minutes as a final drying phase in order to avoid sticking problems. The coated granules are blended together with glidant, lubricant, and/or effervescence in an 8-qt Patterson Kelley V-blender at 20 rpm for 2 minutes.

In certain embodiments the final blended powders in (A) or blended granules in (B), (C) or (D) are compressed to form tablets that are filled into sachets. The final blends are loaded into the hopper of a gravity fed Piccola rotary tablet pressed tooled with 7 stations. Tablets are compressed with the target fill weight to the desired hardness based on the shape and size of the tablet die.

In some embodiments, Plaster of Paris is used to fill the bottle with a hardened mass after setting. Plaster of Paris is filled into sachets with or without diluents. See Table 19.

In further embodiments, Plaster of Paris can be incorporated into the formulations from (A) in order to get a hard set mass with reduced weight (see Table 19).

TABLE 18
Disposal Device Material Preparations.

| Preparation | | | Level | Amount | Total fill |
|---|---|---|---|---|---|
| No. | Ingredient | Function | (w/w) | (mg) | Wt (mg) |
| A | Aerosil | Disposal device agent | 20% | 300 | 1500 |
| | MCC | Diluent/disintegrant | 80% | 1200 | |
| B | Carbopol 71G | Disposal device agent | 100% | 1500 | 1500 |
| C | Carbopol 71G | Disposal device agent | 83% | 1245 | 1500 |
| | Lactose (17%) | Diluent/disintegrant | 17% | 255 | |
| D | Carbopol 71G | Disposal device agent | 5% | 75 | 1500 |
| | MCC:Lactose (1:1) | Diluent/disintegrant | 77% | 1155 | |
| | Mg Stearate | Glidant/lubricant | 1% | 15 | |
| | Sodium Bi-carbonate | Effervescent agent | 17% | 255 | |
| E | Carbopol 71G | Disposal device agent | 20% | 300 | 1500 |
| | MCC | Diluent/disintegrant | 80% | 1200 | |
| F | Carbopol 71G | Disposal device agent | 20% | 300 | 1500 |
| | MCC | Diluent/disintegrant | 80% | 1200 | |
| G | Carbopol 71G | Disposal device agent | 10% | 150 | 1500 |
| | MCC | Diluent/disintegrant | 90% | 1350 | |
| H | Carbopol 71G | Disposal device agent | 20% | 300 | 1500 |
| | MCC | Diluent/disintegrant | 80% | 1200 | |
| I | Cellulose Gum (C- | Disposal device agent | 100% | 1500 | 1500 |
| | 5678) | | | | |
| J | Cellulose Gum (7L2P) | Disposal device agent | 100% | 1500 | 1500 |
| K | Cellulose mix | Disposal device agent | 100% | 1500 | 1500 |
| | (Aquarius ®) | | | | |
| L | Eudragit RSPO | Disposal device agent | 20% | 300 | 1500 |
| | MCC | Diluent/disintegrant | 80% | 1200 | |
| M | Guar gum | Disposal device agent | 20% | 300 | 1500 |
| | MCC | Diluent/disintegrant | 80% | 1200 | |
| N | HPMC (Methocel E5) | Disposal device agent | 100% | 1500 | 1500 |
| O | HPMC (Methocel | Disposal device agent | 47.5% | 713 | 1500 |
| | K100 LV) | | | | |
| | MCC:Lactose (1:1) | Diluent/disintegrant | 51.5% | 773 | |
| | Silicon Dioxide:Mg | Glidant/lubricant | 1% | 15 | |
| | Stearate (1:1) | | | | |
| P | HPMC (Methocel | Disposal device agent | 39.5% | 593 | 1500 |
| | K4M) | | | | |
| | MCC:Lactose (1:1) | Diluent/disintegrant | 59.5% | 893 | |
| | Silicon Dioxide:Mg | Glidant/lubricant | 1% | 15 | |
| | Stearate (1:1) | | | | |
| Q | HPMC (Methocel | Disposal device agent | 30% | 450 | 1500 |
| | K4M) | | | | |
| | Lactose | Diluent/disintegrant | 19.75% | 296 | |
| | Mg Stearate | Glidant/lubricant | 0.25% | 4 | |
| | Sodium Bi-carbonate | Effervescent agent | 50% | 750 | |
| R | HPMC (Methocel | Disposal device agent | 61% | 915 | 1500 |
| | K4M) | | | | |
| | Sodium | Diluent/disintegrant | 26% | 390 | |
| | Carboxymethyl- | | | | |
| | cellulose | | | | |
| | Sodium Bi-carbonate | Effervescent agent | 13% | 195 | |
| S | HPMC AS-LG | Disposal device agent | 100% | 1500 | 1500 |
| T | HPMC/HPC mix | Disposal device agent | 100% | 1500 | 1500 |
| | (Opadry) | | | | |
| U | Hydroxyethyl- | Disposal device agent | 39% | 585 | 1500 |
| | cellulose | | | | |
| | Lactose | Diluent/disintegrant | 60% | 900 | |
| | Mg Stearate | Glidant/lubricant | 1% | 15 | |
| V | Klucel EF | Disposal device agent | 20% | 300 | 1500 |
| | MCC | Diluent/disintegrant | 80% | 1200 | |
| W | L-HPC (hydroxyl- | Disposal device agent | 40% | 600 | 1500 |
| | propyl-cellulose) | | | | |
| | Starch 1500 | Diluent/disintegrant | 59.5% | 893 | |
| | Silicon Dioxide | Glidant/lubricant | 0.5% | 8 | |
| X | PEG 3350 | Disposal device agent | 20% | 300 | 1500 |
| | MCC | Diluent/disintegrant | 80% | 1200 | |
| Y | Plasdone K90 | Disposal device agent | 100% | 1500 | 1500 |
| Z | Polyox | Disposal device agent | 20% | 300 | 1500 |
| | MCC | Diluent/disintegrant | 80% | 1200 | |
| AA | Polyox ™ | Disposal device agent | 100% | 1500 | 1500 |
| AB | Sodium Alginate | Disposal device agent | 100% | 1500 | 1500 |
| | (KELTONE) | | | | |
| AC | Sodium Alginate | Disposal device agent | 18% | 270 | 1500 |
| | (KELTONE) | | | | |
| | MCC | Diluent/disintegrant | 73% | 1095 | |
| | Mg Stearate | Glidant/lubricant | 9% | 135 | |
| AD | Sodium Alginate | Disposal device agent | 20% | 300 | 1500 |
| | (KELTONE) | | | | |
| | MCC | Diluent/disintegrant | 80% | 1200 | |
| AE | Sodium Alginate | Disposal device agent | 100% | 1500 | 1500 |
| | (MANUGEL) | | | | |
| AF | Sodium starch | Disposal device agent | 100% | 1500 | 1500 |
| | glycolate | | | | |
| AG | Starch 1500 | Disposal device agent | 100% | 1500 | 1500 |
| AH | Xanthan Gum | Disposal device agent | 60% | 900 | 1500 |
| | MCC | Diluent/disintegrant | 29% | 435 | |
| | Silicon Dioxide:Mg | Glidant/lubricant | 1% | 15 | |
| | Stearate (1:1) | | | | |
| | Sodium Bi-carbonate | Effervescent agent | 10% | 150 | |
| AI | Xanthan Gum | Disposal device agent | 20% | 300 | 1500 |
| | MCC | Diluent/Disintegrant | 80% | 1200 | |
| AJ | Carbopol 71G | Disposal device agent | 50% | 2500 | 5000 |
| | Guar Gum | Disposal device agent | 50% | 2500 | |
| AK | Carbopol 71G | Disposal device agent | 83% | 4167 | 5000 |
| | Guar Gum | Disposal device agent | 17% | 833 | |
| AL | Carbopol 71G | Disposal device agent | 67% | 3350 | 5000 |
| | Guar Gum | Disposal device agent | 33% | 1650 | |
| AM | Carbopol 71G | Disposal device agent | 17% | 833 | 5000 |
| | Guar Gum | Disposal device agent | 83% | 4167 | |
| AN | Carbopol 71G | Disposal device agent | 33% | 1650 | 5000 |
| | Guar Gum | Disposal device agent | 67% | 3350 | |
| AO | Carbopol 71G | Disposal device agent | 25% | 1250 | 5000 |
| | Guar Gum | Disposal device agent | 50% | 2500 | |
| | PVP K30 | Disposal device agent | 25% | 1250 | |
| AP | Carbopol 71G | Disposal device agent | 33% | 1650 | 5000 |
| | Xanthan Gum | Disposal device agent | 67% | 3350 | |
| AQ | Carbopol 71G | Disposal device agent | 33% | 1650 | 5000 |
| | Carageenan | Disposal device agent | 67% | 3350 | |
| AR | Carbopol 71G | Disposal device agent | 45% | 2250 | 5000 |
| | Guar Gum | Disposal device agent | 45% | 2250 | |
| | Citric Acid | pH modifier | 10% | 500 | |
| AS | Carbopol 71G | Disposal device agent | 45% | 2250 | 5000 |
| | Guar Gum | Disposal device agent | 45% | 2250 | |
| | Oxalic Acid | pH modifier | 10% | 500 | |

TABLE 19
Disposal Device Material Preparations with Plaster of Paris.

| | | | | | Total |
|---|---|---|---|---|---|
| Prepa- | | | | Amount/ | Sachet |
| ration | | | Level | Sachet | fill |
| No. | Ingredient | Function | (w/w) | (mg) | Wt (mg) |
| A | Plaster of | Disposal | 100% | 17000 | 17000 |
| | Paris | device agent | | | |
| B | Plaster of | Disposal | 50% | 2500 | 5000 |
| | Paris | device agent | | | |
| | Xanthan gum | Diluent/ | 50% | 2500 | |
| | | disintegrant | | | |
| C | Plaster of | Disposal | 10% | 200 | 2000 |
| | Paris | device agent | | | |
| | Carbopol | Diluent/ | 90% | 1800 | |
| | | disintegrant | | | |

### Example 9

### Preparations for Inclusion in Disposal Device Material for Neutralizing the Medicament's Therapeutic Effects

The following preparations for inclusion in the disposal device material that neutralizes the therapeutic effects of medicaments are shown in Table 20 and are given by way of example:

In some embodiments, sachets contain disposal device material that includes alkalining agents, organic peroxides, fumed silica or metal oxides to promote oxidation/degradation of the drug product. The preparations listed in Table 20 can be filled directly into sachets or replace, either partially or fully, the diluents in Table 18 to be used as described above.

In certain embodiments, opioid inverse agonists or antagonists can be added to the sachet by replacing, either partially or fully, the diluents in Table 18 with the diluents provided in Table 20.

In further embodiments, thixotropic gelling agents (such as the guar gums) are used to allow the agents listed in Table 20 to come into close contact with the drug product (during agitation) prior to onset of gelation (upon sitting).

TABLE 20
Preparations for Inclusion in Disposal Device Material.

| Preparation | | | Level | Amount/ | Total Sachet |
|---|---|---|---|---|---|
| No. | Ingredient | Function | (w/w) | Sachet (mg) | fill Wt (mg) |
| A | Sodium bisulfate | Alkalinity increasing agent | 1% | 15 | 1500 |
| | MCC | Diluent/disintegrant | 98% | 1470 | |
| | Mg stearate | Glidant/lubricant | 1% | 15 | |
| B | Ammonium carbonate | Alkalinity increasing agent | 1% | 15 | 1500 |
| | MCC | Diluent/disintegrant | 98% | 1470 | |
| | Mg stearate | Glidant/lubricant | 1% | 15 | |
| C | Potassium hydroxide | Alkalinity increasing agent | 0.5% | 7.5 | 1500 |
| | MCC | Diluent/disintegrant | 98.5% | 1477.5 | |
| | Mg stearate | Glidant/lubricant | 1% | 15 | |
| D | Sodium bicarbonate | Alkalinity increasing agent | 10% | 150 | 1500 |
| | MCC | Diluent/disintegrant | 89% | 1335 | |
| | Mg stearate | Glidant/lubricant | 1% | 15 | |
| E | Sodium carbonate | Alkalinity increasing agent | 10% | 150 | 1500 |
| | MCC | Diluent/disintegrant | 89% | 1335 | |
| | Mg stearate | Glidant/lubricant | 1% | 15 | |
| F | Sodium hydroxide | Alkalinity increasing agent | 0.5% | 7.5 | 1500 |
| | MCC | Diluent/disintegrant | 98.5% | 1477.5 | |
| | Mg stearate | Glidant/lubricant | 1% | 15 | |
| G | Trolamine | Alkalinity increasing agent | 0.5% | 7.5% | 1500 |
| | MCC | Diluent/disintegrant | 98.5% | 1477.5 | |
| | Mg stearate | Glidant/lubricant | 1% | 15 | |
| H | Magnesium hydroxide | Alkalinity increasing agent | 10% | 150 | 1500 |
| | MCC | Diluent/disintegrant | 89% | 1335 | |
| | Mg stearate | Glidant/lubricant | 1% | 15 | |
| I | Phosphate buffer | Alkalinity increasing agent | 1% | 15 | 1500 |
| | MCC | Diluent/disintegrant | 98% | 1470 | |
| | Mg stearate | Glidant/lubricant | 1% | 15 | |
| J | Glutamate buffer | Alkalinity increasing agent | 1% | 15 | 1500 |
| | MCC | Diluent/disintegrant | 98% | 1470 | |
| | Mg stearate | Glidant/lubricant | 1% | 15 | |
| K | Carboxymethyl guar | Anion - alkalinity increasing | 5% | 75 | 1500 |
| | | agent, thixotropic VIA | | | |
| | MCC | Diluent/disintegrant | 95% | 1417.5 | |
| | Silicon dioxide | Glidant/lubricant | 0.5% | 7.5 | |
| L | Carboxymethyl- | Anion - alkalinity increasing | 5% | 75 | 1500 |
| | hydroxypropyl guar | agent, thixotropic VIA | | | |
| | MCC | Diluent/disintegrant | 95% | 1417.5 | |
| | Silicon dioxide | Glidant/lubricant | 0.5% | 7.5 | |
| M | Carbamide peroxide | Oxidizing agent | 1% | 15 | 1500 |
| | MCC:lactose (1:1) | Diluent/disintegrant | 98% | 1470 | |
| | Mg stearate | Glidant/lubricant | 1% | 15 | |
| N | Benzoyl peroxide | Oxidizing agent | 1% | 15 | 1500 |
| | MCC:lactose (1:1) | Diluent/disintegrant | 98% | 1470 | |
| | Mg stearate | Glidant/lubricant | 1% | 15 | |
| O | Artelinic acid | Oxidizing agent | 1% | 15 | 1500 |
| | MCC:lactose (1:1) | Diluent/disintegrant | 98% | 1470 | |
| | Mg stearate | Glidant/lubricant | 1% | 15 | |
| P | Fumed silica | Oxidizing agent | 1% | 15 | 1500 |
| | MCC:lactose (1:1) | Diluent/disintegrant | 99% | 1485 | |
| Q | Fumed Titanium | Oxidizing agent | 1% | 15 | 1500 |
| | Dioxide | | | | |
| | MCC:lactose (1:1) | Diluent/disintegrant | 98.5% | 1477.5 | |
| | Silicon dioxide | Glidant/lubricant | 0.5% | 7.5 | |
| R | Polysorbate 80 | Potential oxidizing agent | 5% | 75 | 1500 |
| | MCC:lactose (1:1) | Diluent/disintegrant | 94% | 1410 | |
| | Mg stearate | Glidant/lubricant | 1% | 15 | |
| S | Hydroxy propyl | Potential oxidizing agent | 5% | 75 | 1500 |
| | cellulose | | | | |
| | MCC:lactose (1:1) | Diluent/disintegrant | 94% | 1410 | |
| | Mg stearate | Glidant/lubricant | 1% | 15 | |
| T | Povidone | Potential oxidizing agent | 5% | 75 | 1500 |
| | MCC:lactose (1:1) | Diluent/disintegrant | 94% | 1410 | |
| | Mg stearate | Glidant/lubricant | 1% | 15 | |
| U | PEG 400 | Potential oxidizing agent | 5% | 75 | 1500 |
| | MCC:lactose (1:1) | Diluent/disintegrant | 94% | 1410 | |
| | Mg stearate | Glidant/lubricant | 1% | 15 | |
| V | Naloxone | Opioid inverse agonist agent | 0.03% | 0.4 | 1500 |
| | MCC:corn starch (1:2) | Diluent/disintegrant | 98.7% | 1484.6 | |
| | Mg stearate | Glidant/lubricant | 1% | 15 | |
| W | Naloxone | Opioid inverse agonist agent | 0.5% | 7.5 | 1500 |
| | MCC:corn starch (1:2) | Diluent/disintegrant | 99% | 1477.5 | |
| | Mg stearate | Glidant/lubricant | 1% | 15 | |
| X | Naltrexone | Opioid inverse agonist agent | 3% | 45 | 1500 |
| | MCC:corn starch (1:2) | Diluent/disintegrant | 96% | 1440 | |
| | Mg stearate | Glidant/lubricant | 1% | 15 | |

### Example 10

### General Use of the Disposal Device by the Patient

The quantities and duration of treatment are selected at random for this example and by no means indicates any limit on this invention.

The general contents of the sachet are one dissolvable sachet made of water soluble cellulosic material, containing gypsum, lime or other massing material, in addition to an effervescent agent (an acid, like citric acid, and sodium bicarbonate). The sachet is filled with the appropriate amount of disposal device material to form a solid mass in 50 ml, or more, or less, of water. The sachet is printed, using food grade ink, with clear markings indicating “Not to be ingested.”

For dispensing of prescription product and disposal device, the patient obtains the prescription product from pharmacy and receives a 10 day prescription for a prescription product, and two sachet packets in a 50 ml bottle.

For use of the disposal device, the patient takes a portion of the prescription product. The remaining prescription product is in the prescription product container, along with the two sachets dispensed with the product. Patient adds approximately 30-40 ml of water to the prescription product container, applies the closure, shakes, and deposits to the household waste.

As for the disposal device action, subsequent gelling and massing occurs in the prescription product container while in the household waste. Within 30 minutes to one hour, the remaining prescription product is dispersed and the mass has solidified.

While specific embodiments of the subject invention have been discussed, the above specification is illustrative and not restrictive. One skilled in the art will appreciate that numerous changes and modifications can be made to the invention, and that such changes and modifications can be made without departing from the spirit and scope of the invention. The full scope of the invention should be determined by reference to the claims, along with their full scope of equivalents, and the specification, along with such variations.

What is claimed is:

1. A device for the disposal of unused medicaments, comprising:
(a) a disposal device material; and
(b) a disposal device reservoir,
wherein the disposal device material comprises one or more disposal device agents.

2. The device of claim 1, wherein the one or more disposal device agents have hydrophilic and hydrophobic properties.

3. The device of claim 1, wherein the one or more disposal device agents comprise a polymeric or non-polymeric composite material.

4. The device of claim 1, wherein the one or more disposal device agents are selected from a group consisting of carbomers, polyacrylic acid, hydroxypropyl methylcellulose: hydroxypropyl cellulose mixture, polyvinylpyrrolidone, polyethylene oxide, methylcellulose, xanthan gum, guar gum, hydroxypropyl cellulose, polyethylene glycol, methacrylic acid copolymer, colloidal silicon dioxide, cellulose gum, starch, sodium starch glycolate, sodium alginate, and combinations thereof.

5. The device of claim 1, wherein the disposal device further comprises a neutralizing component.

6. The device of claim 5, wherein the neutralizing component is an acidifying agent, nitrosylating agent, decomposition agent, free-radical forming agent, or catalytic agent.

7. The device of claim 1, wherein the disposal device material further comprises an opioid inverse agonist, an opioid antagonist, or a combination thereof.

8. The device of claim 1, wherein the disposal device material further comprises a binder, alkalining agent, disintegrant, dispersing agent, effervescent agent, a hardening agent, or a combination thereof.

9. The device of claim 1, wherein the disposal device material is in the form of a powder, pellet, bead, beadlet, granule, or a combination thereof.

10. The device of claim 1, wherein the disposal device reservoir is in the form of a sachet, packet, or straw.

11. The device of claim 1, wherein the disposal device reservoir is in the form of a blister or a rib embedded in the walls or in the closure of a medicament container, wherein the medicament container is a container that houses the medicaments.

12. The device of claim 1, wherein the disposal device reservoir is in the form of a chamber in a closure or a wall or bottom of a medicament container

13. The device of claim 1, wherein the disposal device reservoir comprises a material that is dissolvable when contacted by a solvent.

14. A device for the disposal of unused medicaments, comprising a medicament container that comprises disposal device material embedded within sides or bottom or cap, or a combination thereof, of the medicament container, wherein the disposal device material comprises one or more disposal device agents.

15. A method of disposing of unused medicaments, comprising mixing the unused medicament with a disposal device material and a solvent, wherein the disposal device material comprises one or more disposal device agents.

16. The method of claim 15, wherein the one or more disposal device agents have hydrophilic and hydrophobic properties.

17. The method of claim 15, wherein the one or more disposal device agents comprise a polymeric or non-polymeric composite material.

18. The method of claim 15, wherein the one or more disposal device agents are selected from a group consisting of carbomers, polyacrylic acid, hydroxypropyl methylcellulose: hydroxypropyl cellulose mixture, polyvinylpyrrolidone, polyethylene oxide, methylcellulose, xanthan gum, guar gum, hydroxypropyl cellulose, polyethylene glycol, methacrylic acid copolymer, colloidal silicon dioxide, cellulose gum, starch, sodium starch glycolate, sodium alginate, and combinations thereof.

19. The method of claim 15, wherein the solvent is water, alcohol, vinegar, or bleach.

20. The method of claim 15, wherein the disposal device further comprises a neutralizing component.

21. The method of claim 20, wherein the neutralizing component is an acidifying agent, nitrosylating agent, decomposition agent, free-radical forming agent, or catalytic agent.

22. The method of claim 15, wherein the disposal device material further comprises an opioid inverse agonist, an opioid antagonist, or a combination thereof.

23. The method of claim 15, wherein the disposal device material further comprises a binder, alkalining agent, disintegrant, dispersing agent, effervescent agent, a hardening agent, or a combination thereof.

24. The device of claim 15, wherein the disposal device material is in the form of a powder, pellet, bead, beadlet, granule, or a combination thereof.

25. The method of claim 15, wherein the disposal device material is in a disposal device reservoir or closure.

26. The method of claim 25, wherein the disposal device reservoir is in the form of a sachet, packet, or straw.

27. The method of claim 25, wherein the disposal device reservoir is in the form of a blister or a rib embedded in the walls or in the closure of a medicament container, and wherein the medicament container is a container that houses the medicaments.

28. The method of claim 15, wherein the disposal device reservoir is in the form of a chamber in a closure or a wall or bottom of a medicament container.

29. The method of claim 15, wherein the disposal device reservoir comprises a material that is dissolvable when contacted by a solvent.

30. The method of claim 15, wherein the unused medicament is selected from the group consisting of a prescription drug, over-the-counter drug, vitamin, nutritional supplement, plant-derived product, and fermented supplement.

31. The method of claim 30, wherein the prescription drug is a schedule I, II, or III, or IV drug.

32. The method of claim 15, wherein the unused medicament and the disposal device material is mixed within a container that houses the unused medicament.

33. The method of claim 32, wherein the disposal device material is added to the container that houses the unused medicament.

34. The method of claim 32, wherein the disposal device material is in a disposal device reservoir in the form of a chamber within a closure or lid of a medicament container or within one or more walls or bottom of the medicament container.

35. A method of disposing of unused medicaments, comprising mixing the unused medicament with:
(a) a disposal device material contained in a sachet, and
(b) a solvent;
wherein the disposal device material comprises one or more disposal device agents; and
wherein the sachet is added to a container that houses the unused medicament.
